(19) United States
(12) Patent Application Publication
(10) Pub. No.: US 2025/0217815 A1
(43) Pub. Date: Jul. 3, 2025

(54) SYSTEM AND METHOD FOR A CONFIGURATION DRIVEN PRODUCT CARBON FOOTPRINT FRAMEWORK

(71) Applicant: Chevron U.S.A. Inc., San Ramon, CA (US)

(72) Inventors: Gil Josue Reyes Melendez, Katy, TX (US); Ammar Esper, Pearland, TX (US); Robb Morgan, Murrieta, CA (US); Armando Carrasquillo, Sugar Land, TX (US); Lily Dang, Houston, TX (US); Alex Lam, Houston, TX (US); Jerry Che, Houston, TX (US); Derek Alexander de Oliveira, Meadow Vista, CA (US)

(21) Appl. No.: 19/003,930

(22) Filed: Dec. 27, 2024

Related U.S. Application Data
(60) Provisional application No. 63/615,212, filed on Dec. 27, 2023.

(51) Int. Cl. G06Q 30/018

(52) U.S. Cl. CPC G06Q 30/018

(57) ABSTRACT

A computer-implemented method for establishing a product carbon footprint (PCF) framework for a corporate entity may include presenting multiple landscapes, where each landscape includes multiple selection options to determine how to generate a PCF value for the corporate entity. Each landscape is generated in real time and is based on the one or more selections to the selection options of the previous landscape. Each selection is verified to fall within applicable selection guidelines. Also, a source of the initial emission-related data is designated in real time based on the selections.

### CROSS-REFERENCE TO RELATED APPLICATIONS

This application claims priority to U.S. Provisional Patent Application Ser. No. 63/615,212 titled “System And Method For A Configuration Driven Product Carbon Footprint Framework” and filed on Dec. 27, 2023, the entire contents of which are hereby incorporated herein by reference.

### TECHNICAL FIELD

The present application is related to management of carbon footprints and, more particularly, to systems and methods for configuration driven product carbon footprint (PCF) frameworks.

### BACKGROUND

A number of products currently exist for generating a PCF value. These products are associated with a value chain that involves a variety of participants ranging from producers to consumers. Certain of these participants may wish to focus their efforts on reducing the emissions associated with their products. Thus, it is presently recognized in many industries that it can be valuable to understand the emissions of not only an overall value chain, but also each segment/product within the value chain so that efforts can be focused on the most desirable emissions reduction opportunities.

Current efforts to understand emissions associated with value chains are complicated by the lack of a common language and/or a lack of standards across industries and participants in value chains to certify and deliver reliable data that can help encourage and incentivize lower carbon outcomes. Each entity that collects emission-related data to generate a PCF value may have different processes as to, for example, how the data is acquired, how often the data is acquired, how the acquired raw data is formatted, and the flow and processing of the data within the organization. These differences present a challenge as to how software used to generate a PCF value can be sufficiently customized to suit a particular entity.

### SUMMARY

In general, in one aspect, the disclosure relates to a computer-implemented method for establishing a product carbon footprint (PCF) framework for a corporate entity. The computer-implemented method may include presenting a first landscape that includes a first plurality of selection options to determine how to generate a PCF value for the corporate entity. The computer-implemented method may also include obtaining a first selection of a first selection option among the first plurality of selection options from a user of a customer, where the first selection includes first instructions for processing initial emission-related data to generate first emission-related data, and where the initial emission-related data is associated with a business segment of the corporate entity. The computer-implemented method may further include verifying, in real time, that the first selection falls within a first set of current guidelines. The computer-implemented method may also include designating, in real time, a source of the initial emission-related data. The computer-implemented method may further include presenting, based on the first selection, a second landscape that includes a second plurality of selection options to further determine how to generate the PCF value for the corporate entity. The computer-implemented method may also include obtaining a second selection of a second selection option among the second plurality of selection options from the user of the customer, where the second selection includes second instructions for processing the first emission-related data to generate second emission-related data, and where the second emission-related data is used to generate the PCF value. The computer-implemented method may further include verifying, in real time, that the second selection falls within a second set of current guidelines. The computer-implemented method may also include presenting, based on the first selection and the second selection, a third landscape that includes a third plurality of selection options to further determine how to generate the PCF value for the corporate entity. The computer-implemented method may further include obtaining a third selection of a third selection option among the third plurality of selection options from the user of the customer, where the third selection instructs the first emission-related data generated by the first selection to be an input for the second selection. The computer-implemented method may also include verifying, in real time, that the third selection falls within a third set of current guidelines that apply to tying the first selection to the second selection.

In another aspect, the disclosure relates to a product carbon footprint (PCF) determination apparatus that includes a PCF framework module and a controller communicably coupled to the PCF framework. The controller may be configured to present, using a landscape module of the PCF framework module, a first landscape that includes a first plurality of selection options to determine how to generate a PCF value for the corporate entity. The controller may also be configured to obtain a first selection of a first selection option among the first plurality of selection options from a customer, where the first selection includes first instructions for processing initial emission-related data to generate first emission-related data, and where the initial emission-related data is associated with a business segment of the customer. The controller may further be configured to verify, using a selection processing module of the PCF framework module, in real time, that the first selection falls within a first set of current guidelines. The controller may also be configured to designate, using a data source designation module of the PCF framework module, in real time, a source of the initial emission-related data. The controller may further be configured to present, based on the first selection and using the landscape module of the PCF framework module, a second landscape that includes a second plurality of selection options to further determine how to generate the PCF value for the corporate entity. The controller may also be configured to obtain a second selection of a second selection option among the second plurality of selection options from the customer, where the second selection includes second instructions for processing the first emission-related data to generate second emission-related data, and where the second emission-related data is used to establish the PCF value. The controller may further be configured to verify, in real time using the selection processing module of the PCF framework module, that the second selection falls within a second set of current guidelines. The controller may also be configured to present, using the landscape module of the PCF framework module, based on the first selection and the second selection, a third landscape that includes a third plurality of selection options to further determine how to generate the PCF value for the corporate entity. The controller may further be configured to obtain a third selection of a third selection option among the third plurality of selection options from the customer, where the third selection instructs the first emission-related data generated by the first selection to be an input for the second selection. The controller may also be configured to verify, in real time using the selection processing module of the PCF framework module, that the third selection falls within a third set of current guidelines that apply to tying the first selection to the second selection.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, the same reference numerals used in different figures may designate like or corresponding but not necessarily identical elements.

FIG. 1 shows a system for determining PCF values using a configuration driven PCF framework module according to certain example embodiments.

FIG. 2 shows a system diagram of a controller of the configuration driven PCF framework module of FIG. 1 according to certain example embodiments.

FIG. 3 shows a computing device in accordance with certain example embodiments.

FIG. 4 shows a flowchart of a method for establishing a configuration driven PCF framework according to certain example embodiments.

FIGS. 5 through 13 show examples of screenshots that may be presented during implementation of the method of FIG. 4.

FIGS. 14 through 20 show examples of screenshots that may be presented in accessing previously-developed frameworks and related data according to certain example embodiments.

FIG. 21 shows a general system architecture diagram for a system for determining PCF values using a configuration driven PCF framework module according to certain example embodiments.

### DETAILED DESCRIPTION

The example embodiments discussed herein are directed to systems and methods for using a configuration driven PCF framework to determine a PCF value. Example embodiments can be used to determine PCF values in one or more of any of a number of industries and/or for a customer functioning at any point along a supply chain. Examples of industries for which example embodiments can be used can include, but are not limited to, oil and gas (e.g., exploration, production, refining), chemical production and/or manufacturing, aquaculture, oceanography, and electric power.

Example embodiments can be used so that each customer, or one or more users of a customer, may establish a customized PCF framework to generate a PCF value for that customer or portion thereof. Example embodiments described herein can be designed to comply with certain standards and/or requirements. Examples of entities that set such standards and/or requirements can include, but are not limited to, the Environmental Protection Agency (EPA), the World Resources Institute (WRI), the European Union (EU), the Center For Resource Solutions (CRS), the Intergovernmental Panel on Climate Change (IPCC), and the International Standards Organization (ISO). Example embodiments are designed to generate a framework for determining a PCF value based on user input. Example embodiments are designed to respond to each user input in generating a framework and in providing a PCF value once the framework is established in real time. As defined herein, real time means substantially instantaneously, allowing for slight (e.g., less than a few seconds) communication delays, processing delays, and the like associated with computer functions and computer-to-computer communication.

The use of the terms “about”, “approximately”, and similar terms applies to all numeric values, whether or not explicitly indicated. These terms generally refer to a range of numbers that one of ordinary skill in the art would consider as a reasonable amount of deviation to the recited numeric values (i.e., having the equivalent function or result). For example, this term may be construed as including a deviation of ±10 percent of the given numeric value provided such a deviation does not alter the end function or result of the value. Therefore, a value of about 1% may be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

If a component of a figure is described but not expressly shown or labeled in that figure, the label used for a corresponding component in another figure can be inferred to that component. Conversely, if a component in a figure is labeled but is not described, the description for such component can be substantially the same as the description for the corresponding component in another figure. The numbering scheme for the various components in the figures herein is such that each component is a three-digit number or a four-digit number, and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of using configuration driven PCF frameworks to determine PCF values will be described more fully hereinafter with reference to the accompanying drawings, in which example embodiments of using configuration driven PCF frameworks to determine PCF values are shown. Using configuration driven PCF frameworks to determine PCF values may, however, be embodied in many different forms and should not be construed as limited to the example embodiments set forth herein. Rather, these example embodiments are provided so that this disclosure will be thorough and complete, and will fully convey the scope of using configuration driven PCF frameworks to determine PCF values to those of ordinary skill in the art. Like, but not necessarily the same, elements (also sometimes called components) in the various figures are denoted by like reference numerals for consistency.

Terms such as “first”, “second”, “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. This list of terms is not exclusive. Such terms are not meant to denote a preference or a particular orientation unless explicitly stated, and they are not meant to limit embodiments of using configuration driven PCF frameworks to determine PCF values. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

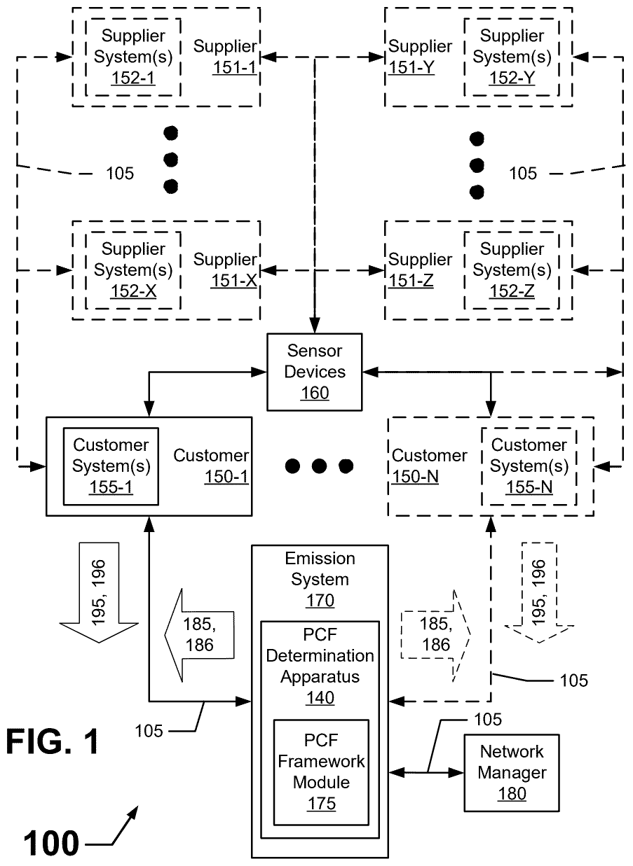

FIG. 1 shows a system 100 for determining PCF values according to certain example embodiments. The system 100 includes multiple components. In this case, the system 100 includes an emission system 170, a network manager 180, one or more sensor devices 160, one or more customers 150 (including one or more associated customer systems 155), and one or more suppliers 151 (including one or more associated supplier systems 152). The emission system 170 in this example includes a PCF determination apparatus 140, which includes an example PCF framework module 175. The system 100 also includes a number of communication links 105 to facilitate communication between various components within the system 100.

The system 100 can include any number of customers 150. In this example, there can be N customers 150 (customer 150-1 through customer 150-N). A customer 150 can provide goods and/or services. Determining the PCF value (also sometimes referred to as the PCF herein) of a customer 150 can be based, at least in part, on generating these goods and/or services. Each customer 150 can be an entity (e.g., a company, an organization, a group, an association) that is attempting to determine its PCF. A customer 150 can attempt to determine its PCF for mandatory (compliance) reporting, for voluntary disclosure, for budgeting purposes, and/or for some other reason. A customer 150 can be of any size (e.g., in terms of the number of employees, in terms of geographic location(s), in terms of the number of facilities) and/or any type (e.g., in terms of the industry served, in terms of the types of facilities, in terms of hierarchy (e.g., conglomerate, parent entity, subsidiary, stand-alone entity)).

A customer 150 can be an entity that is required to report and/or has decided to voluntarily report or track its PCF. The customer 150 can be a corporate entity that has multiple business segments. The customer 150 can be represented by one or more individuals (e.g., employees, officers) and/or other entities (e.g., an accounting firm, an auditing firm) when using some or all of the example PCF determination apparatus 140. In some cases, a customer 150 in one situation can be a supplier 151 to another customer 150 in another situation. In some cases, initial emission-related data 195 may be provided to the PCF determination apparatus 140 (including the PCF framework module 175) by a customer 150. In this way, a customer 150 may be considered a source of initial emission-related data 195.

A customer 150 can use one or more customer systems 155, which may include a display (e.g., a GUI). A customer system 155 of a customer 150 can interact with (e.g., send data to, obtain data from) the emission system 170 (or portions thereof, such as the PCF determination apparatus 140 and/or the PCF framework module 175 thereof) and/or one or more suppliers 151 of the customer 150 via an application interface (similar to an application interface 226 discussed below) and using one or more communication links 105. Examples of a customer system 155 can include, but are not limited to, a cell phone, a laptop computer, a desktop computer, an electronic tablet, and a specialized handheld device. A customer system 155 can be considered a type of computer device, as discussed below with respect to FIG. 3. In some cases, initial emission-related data 195 may be provided to the PCF determination apparatus 140 (including the PCF framework module 175) by a customer system 155. In this way, a customer system 155 may be considered a source of initial emission-related data 195.

Each customer 150 can have one or more optional suppliers 151. In alternative embodiments, a customer 150 can have no suppliers 151. A supplier 151 can provide goods and/or services to a customer 150, which in turn are used by the customer 150 to generate its own goods and/or services. The goods and/or services provided by a supplier 151 to a customer 150 can affect the PCF of the customer 150. As a result, certain data (e.g., energy usage, emission data) can be provided (using one or more communication links 105) by the supplier 151 to a customer 150 so that the data can be used to determine the PCF of the customer 150. In this case, customer 150-1 can have X suppliers 151 (supplier 151-1 through supplier 151-X). As another example, customer 150-N can have a number of suppliers 151 (supplier 151-Y through supplier 151-Z). A supplier 151 can supply goods and/or services to more than one customer 150. In some cases, a supplier 151 to a customer 150 in one situation can itself be a customer 150 in another situation. In some cases, initial emission-related data 195 may be provided to the PCF determination apparatus 140 (including the PCF framework module 175) by a supplier 151. In this way, a supplier 151 may be considered a source of initial emission-related data 195.

A supplier 151 can use and/or include one or more supplier systems 152, which may include a display (e.g., a GUI). For example, supplier 151-1 can use and/or include supplier system 152-1, supplier 151-X can use and/or include supplier system 152-X, supplier 151-Y, and can use and/or include supplier system 152-Y, and supplier 151-Z can use and/or include supplier system 152-Z. A supplier system 152 of a supplier 151 can interact with (e.g., send data to, obtain data from) one or more customer systems 155 of one or more customers 150 and/or one or more other supplier systems 152 of one or more other suppliers 151 of a customer 150 via an application interface (similar to an application interface 226 discussed below) and using one or more communication links 105.

Examples of a supplier system 152 can include, but are not limited to, a cell phone, a laptop computer, a desktop computer, an electronic tablet, and a specialized handheld device. A supplier system 152 can be considered a type of computer device, as discussed below with respect to FIG. 3. In some cases, initial emission-related data 195 may be provided to the PCF determination apparatus 140 (including the PCF framework module 175) by a supplier system 152. In this way, a supplier system 152 may be considered a source of initial emission-related data 195.

Each sensor device 160 of the system 100 includes one or more sensors that measure one or more parameters (e.g., pressure, flow rate, temperature, opacity, heat rate, humidity, fluid content, voltage, current, chemical elements in a fluid). Examples of a sensor of a sensor device 160 can include, but are not limited to, a temperature sensor, a flow sensor, a pressure sensor, a proximity sensor, a gas spectrometer, a voltmeter, an ammeter, and a camera. A sensor device 160 can be integrated with or measure a parameter associated with one or more components of the system 100. For example, a sensor device 160 can be integrated with or connected to a piece of equipment of a customer 150 at one of the sites of the customer 150. As another example, a sensor device 160 can be integrated with or connected to a piece of equipment of a supplier 151, where the equipment is used to provide a product and/or service to a customer 150.

In some cases, a parameter measured by a sensor device 160 can be associated with initial emission-related data 195. In this way, a sensor device 160 may be considered a source of initial emission-related data 195. In some cases, a number of sensor devices 160, each measuring a different parameter, can be used in combination to determine and confirm whether a controller 204 should take a particular action (e.g., operate a valve, operate or adjust the operation of a pump, send a notification). When a sensor device 160 includes its own controller (e.g., a controller 204), or portions thereof, then the sensor device 160 can be considered a type of computer device, as discussed below with respect to FIG. 3.

The network manager 180 of the system 100 can be configured to control and/or communicate with the PCF determination apparatus 140 (including the example PCF framework module 175 thereof). For example, the network manager 180 may be configured to provide updated instructions for the customers 150. As another example, the network manager 180 can facilitate communication between the PCF determination apparatus 140 (including the example PCF framework module 175 thereof) of the emission system 170 and one or more other PCF determination apparatuses (including the example PCF framework modules thereof) of one or more other emission systems that are communicating with other customers outside the system 100.

In some cases, the network manager 180 can be or be controlled, in whole or in part, by a user. Examples of a user can include, but are not limited to, a business owner, a customer 150 (including an employee or other representative thereof), a supplier 151 (including an employee or other representative thereof), a research scientist, an analyst, a compliance manager, an engineer, a company representative, an inspector, a consultant, a government representative, a regulator, a contractor, and a manufacturer's representative. In some cases, initial emission-related data 195 may be provided to the PCF determination apparatus 140 (including the PCF framework module 175) by the network manager 180. In this way, the network manager 180 may be considered a source of initial emission-related data 195.

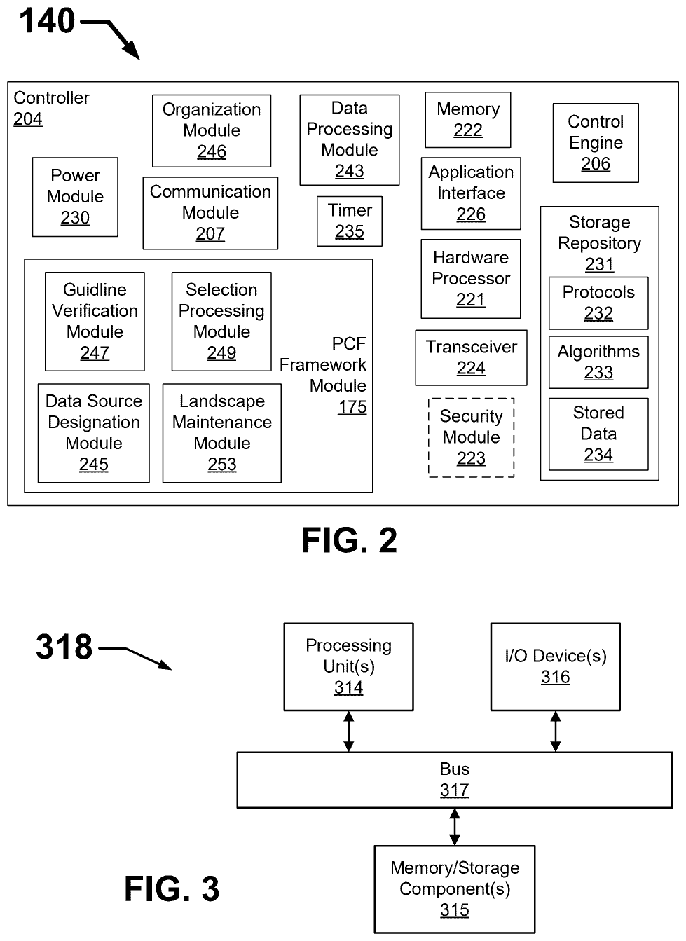

The network manager 180 may be substantially similar to some or all of the controller 204 of the PCF determination apparatus 140 (including the example PCF framework module 175 thereof) of the emission system 170, as described below with respect to FIG. 2. For example, the network manager 180 may include a controller that has one or more components and/or similar functionality to some or all of the controller 204. Alternatively, the network manager 180 may include one or more of a number of features in addition to, or altered from, the features of the controller 204. As described herein, control and/or communication with the network manager 180 may include communicating with the PCF determination apparatus 140 (including the example PCF framework module 175 thereof) in the same system 100 and/or with one or more other PCF determination apparatuses (including the example PCF framework modules thereof) in one or more other systems. In such a case, the network manager 180 may facilitate such control and/or communication. The network manager 180 may be called by other names, including but not limited to a master controller, a network controller, and an enterprise manager. The network manager 180 may be considered a type of computer device, as discussed below with respect to FIG. 3.

In certain example embodiments, the emission system 170, including components (e.g., the PCF determination apparatus 140, the example PCF framework module 175) thereof, may be configured to perform any of a number of functions associated with determining a PCF value for a customer 150. For example, the PCF framework module 175 of the PCF determination apparatus 140 of the emission system 170 may be configured to present a landscape 185 that allows one or more users of a customer 150 to generate a framework under which a PCF value 186 is generated. A PCF value 186 may be designed to quantify the emissions associated with delivering a product or service of a customer 150 (e.g., a company, a division of a company) to an end-use consumer. For example, if a customer 150 is an integrated oil company, a PCF value 186 may include evaluating the emissions associated with the production of crude oil, the transportation of the crude oil, the refining of the crude oil, and the transportation of the resulting gasoline to a gas station for use by a consumer.

As a more specific instance of this example over some defined period of time, the production of crude oil may average +32 kgCO₂e per barrel, the transportation of the crude oil may average +6 kgCO₂e per barrel, the refining of the crude oil may average +38 kgCO₂e per barrel, and the transportation of the resulting gasoline to a gas station for use by a consumer may average +5 kgCO₂e per barrel. As a result, the PCF value 186 would be 81 mt CO₂e per barrel. The framework by which the PCF value 186 is generated in this case may be developed using example embodiments. In alternative example, some or all of the values listed above may vary.

When the landscape 185 is presented (e.g., on the display of a customer system 155) to a user of the customer 150, the user may make one or more selections 196 among multiple selection options within the landscape 185. A selection 196 made by a user may add an element to the landscape 185, remove an element from the landscape 185, enter freeform text, select a menu item, select a radio button, change a configuration of one or more elements of the landscape 185, and/or make some other selection of a selection option within the landscape 185. The landscape 185 may change with each selection 196 of a selection option made by a user. Once all selections 196 of a landscape 185 (or of multiple landscapes 185 that are connected to each other) are made by a user, a framework is established. If a framework is modified based on one or more selections 196 by a user, a new framework may be established. In some cases, multiple users of a customer 150 may make one or more selections 196 in the development and establishment of a framework.

When a selection 196 of a selection option in a landscape 185 is received by the PCF framework module 175 of the PCF determination apparatus 140 of the emission system 170, the PCF framework module 175 (or a component thereof) may perform one or more of a number of checks or validations with respect to the selection 196. For example, the PCF framework module 175 (or a component thereof) may verify in real time that the selection 196 falls within a set of guidelines that currently apply to the initial emission-related data 195 for that customer 150. A guideline may be or include a rule or set of rules that govern over a particular aspect (e.g., over data, over users, over suppliers 151, over customers 150) of the process used to generate a PCF value. A guideline may be set and/or modified by a user (e.g., a customer 150, a supplier 151, an auditor), by regulation, by industry standard, by default, and/or by some other entity or factor.

Examples of guidelines may include, but are not limited to, the initial emission-related data 195 required for the selection 196, the one or more sources from which such initial emission-related data 195 may be obtained, whether such one or more sources of the initial emission-related data 195 are available to provide the initial emission-related data 195, whether the initial emission-related data 195 is reliable, whether a particular selection 196 is valid in light of the available selection options, whether the user submitted the selection 196 has the authority to do so, and whether the selection 196 contradicts a previous selection 196 made by a different user having a higher level authority relative to the current user.

As another example, the PCF framework module 175 (or a component thereof) may designate a source (or multiple sources) of the initial emission-related data 195 required for the selection 196. Such a designation may be based on the verification discussed above with respect to the set of guidelines that apply to the initial emission-related data 195. Such a designation may be done in real time so that immediate feedback may be provided to a user in the event that there are issues or unusual circumstances (e.g., there is no actual initial emission-related data 195 available from a customer 150, a supplier 151, or a sensor device 160, and so the initial emission-related data 195 is to be provided by a third-party source (e.g., via the network manager 180) as an approximation) as a result of the selection 196 made by the user.

As yet another example, the PCF framework module 175 (or a component thereof) may analyze (e.g., verify that an applicable guideline is followed) a selection 196 in the form of a link (a type of selection option) between two prior selections 196 in the form of processing steps (a type of selection option) for data (e.g., initial emission-related data 195, partially processed initial emission-related data 195) with the ultimate goal of generating a PCF value 186. For instance, the PCF framework module 175 may verify that the output of one process step (e.g., initial emission-related data 195 organized after being received from one or more sources) formed from one or more selections 196 of a landscape 185 may be used directly as an input for another process step (e.g., formatting the organized initial emission-related data 195) formed from one or more other selections of a different landscape 185 based on a selection 196 of a selection option that links the two process steps as part of a process flow (i.e., the framework).

In certain example embodiments, the PCF framework module 175 (or portion thereof, such as the guideline verification module 247) is configured to determine, in real time, upon receiving a selection 196, which one or more guidelines are applicable for evaluating the selection 196. In some cases, a guideline used to evaluate a selection 196 is within the stored data 234 on the storage repository 231. In such cases, the PCF framework module 175 may be configured to look up and utilize, in real time, the applicable guideline in the storage repository 231 to evaluate a selection 196. In other cases, a guideline required to evaluate a selection 196 is not stored in the storage repository 231. In such cases, the PCF framework module 175 may be configured to, in real time, identify what one or more guidelines are needed to evaluate a selection 196, identify one or more reliable third party sources from which the one or more guidelines may be obtained, retrieve the one or more guidelines from the one or more reliable third party sources, and utilize the one or more guidelines to evaluate a selection 196.

In some cases, the information required to determine whether a selection 196 falls within a guideline is within the stored data 234 on the storage repository 231. In such cases, the PCF framework module 175 (or portion thereof, such as the guideline verification module 247) may be configured to look up and utilize, in real time, the information in the storage repository 231 to determine if a selection 196 falls within an applicable guideline. In other cases, the information required to determine whether a selection 196 falls within a guideline is not stored in the storage repository 231. In such cases, the PCF framework module 175 may be configured to, in real time, identify what information is needed to evaluate the selection 196 relative to a guideline, identify a reliable third party source from which the information may be obtained, retrieve the information from the reliable third party source, and utilize the information to determine if a selection 196 falls within an applicable guideline.

In addition to evaluating a selection 196 with respect to one or more applicable guidelines, the PCF framework module 175 (or portion thereof, such as the guideline verification module 247) may be configured to suggest, in real time, changes and/or alternatives to a selection 196 so that an amended or new subsequent selection 196 may fall within all applicable guidelines. For example, if the PCF framework module 175 determines that a selection 196 falls outside one or more applicable guidelines, the PCF framework module 175 may be configured to communicate, in real time, the reason that the selection 196 falls outside of one or more of the applicable guidelines. In such a case, the PCF framework module 175 may additionally or alternatively identify, in real time, a deficiency with the selection 196 and communicate, in real time, suggestions as to how the selection 196 may be altered so that the modified selection 196 falls within applicable guidelines. In addition, or in the alternative, the PCF framework module 175 may identify and communicate, in real time, one or more alternative selections 196 that may serve as a substantially functional equivalent as the original selection 196 and that fall within applicable guidelines.

Ultimately, when all of the selections 196 of various selection options are made within one or more of the landscapes 185 to set the framework, the PCF determination apparatus 140 uses the framework established by the one or more users and validated by the PCF framework module 175 to generate a PCF value 186. The PCF determination apparatus 140 may then present the PCF value 186 to the customer 150 and/or some other entity at the direction of the customer 150.

In view of the above, the PCF framework module 175 of the PCF determination apparatus 140 of the emission system 170 shown in FIG. 1 may be configured to help establish, based on the current framework (e.g., just created, selected from a history of frameworks), in real time and with a continual ability to be modified by a user, how a PCF value 186 is generated using some or all of the initial emission-related data 195. One or more other components or portions of the PCF determination apparatus 140 may be used to enact one or more of the selections 196 of various selection options from one or more landscapes 185 that make up the framework. For example, when a first selection 196 in a process flow that makes up a framework is to organize the initial emission-related data 195, the PCF determination apparatus 140 (or portion thereof) may organize the initial emission-related data 195 according to one or more protocols.

The initial emission-related data 195 may be raw, partially processed, and/or fully processed when received by the PCF determination apparatus 140. A source of the initial emission-related data 195 may be one or more sensor devices 160, one or more suppliers 151 (including one or more supplier systems 152), one or more customers 150 (including one or more customer systems 155), and/or the network manager 180. For example, in certain example embodiments, each customer 150 can use a customer system 155 to send initial emission-related data 195 to the PCF determination apparatus 140 of the emission system 170 using the communication links 105. The initial emission-related data 195 is output by one or more of the customer systems 155 to the PCF determination apparatus 140 of the emission system 170 using one or more protocols and/or one or more algorithms, which may be uniformly applied across multiple business segments of the customer 150 or unique to one or more particular business segments. In some cases, in addition or in the alternative, the initial emission-related data 195 may be received by the PCF determination apparatus 140 directly from a sensor device 160, a supplier 151, a supplier system 152, and/or a customer 150 via the communication links 105.

The initial emission-related data 195 can have any of a number of formats and/or sizes. For example, the initial emission-related data 195 can be a single number. As another example, the initial emission-related data 195 can be a series of numbers. In any case, the initial emission-related data 195 are put into a particular format (e.g., converted into one or more particular units of measure, split up and/or combined with one or more other parts of the initial emission-related data 195 to fall within a range of time) that is acceptable or required by the PCF determination apparatus 140. The PCF determination apparatus 140 can be configured to organize, filter, process, summarize, and/or present summaries of the initial emission-related data 195 received from each customer 150.

When the initial emission-related data 195 received by the PCF determination apparatus 140 is raw or partially processed, the PCF determination apparatus 140 may be configured, depending on the selections 196 received, to organize, process (e.g., format, filter), and/or fully process the initial emission-related data 195 using one or more protocols based on the PCF framework (also sometimes more simply referred to as a framework herein) established using the example PCF framework module 175. The initial emission-related data 195 may be associated with one or more business segments of a customer 150.

When a selection 196 of a selection option of a landscape 185 is to organize the initial emission-related data 195, the PCF determination apparatus 140 may use one or more organizing factors (e.g., date, business segment, supplier 151, product line, service line, fuel) to generate multiple subsets of organized data, where the organized data may be the same as, or different than (e.g., different formatting), the initial emission-related data 195. Each file of initial emission-related data 195 may include metadata (e.g., time stamp, location, device (e.g., sensor device 160) identification) that may be used to organize the initial emission-related data 195.

The network manager 180 can communicate directly with the PCF determination apparatus 140 (or portions thereof) of the emission system 170. The PCF determination apparatus 140 can communicate directly with each of the customers 150, including any associated customer systems 155 and/or sensor devices 160. In some cases, the PCF determination apparatus 140 may also communicate directly with one or more of the suppliers 151, including any associated supplier systems 152 and/or sensor devices 160, of a customer 150. Further, each of the suppliers 151, including any associated supplier systems 152, can communicate directly with each other and/or with each of the customers 150, including any associated customer systems 155. In some cases, two or more of the customers 150, including any associated customer systems 155, can communicate directly with each other. Such communication can occur using the communication links 105.

Each communication link 105 can include wired (e.g., Class 1 electrical cables, Class 2 electrical cables, electrical connectors, Power Line Carrier, RS485) and/or wireless (e.g., Wi-Fi, Zigbee, visible light communication, cellular networking, satellite, Bluetooth, WirelessHART, ISA100) technology. A communication link 105 can be used for the transmission of signals (e.g., communication signals, control signals, data) between the customer systems 155, the network manager 180, the supplier systems 152, and the PCF determination apparatus 140 (including portions thereof, such as the controller 204 and the PCF framework module 175) in the system 100.

FIG. 2 shows a system diagram of the PCF determination apparatus 140 of the emission system 170 (including the PCF framework module 175) of FIG. 1. Specifically, in this case, the PCF determination apparatus 140 includes a controller 204 according to certain example embodiments. Referring to the description above with respect to FIG. 1, the controller 204 of the PCF determination apparatus 140 of FIG. 2 can include multiple components. For example, in this case, the controller 204 of the PCF determination apparatus 140 includes a control engine 206, a data processing module 243, an organization module 246, a communication module 207, a timer 235, a power module 230, a storage repository 231, a hardware processor 221, memory 222, a transceiver 224, an application interface 226, a security module 223, and the PCF framework module 175. In this case, the PCF framework module 175 includes a data source designation module 245, a guideline verification module 247, a selection processing module 249, and a landscape maintenance module 253. The various components of the controller 204 may be centrally located. In addition, or in the alternative, some of the components of the controller 204 may be located remotely from (e.g., in the cloud, at an office building) one or more of the other components of the controller 204.

The components shown in FIG. 2 are not exhaustive, and in some embodiments, one or more of the components shown in FIG. 2 may not be included in the controller 204 of the PCF determination apparatus 140. For example, if there are multiple PCF determination apparatuses 140 in a system (e.g., system 100), where each PCF determination apparatus 140 has its own controller 204, then one controller 204 can be subservient to the other controller 204. In such cases, the subservient controller 204 can lack some of the components (e.g., a PCF framework module 175 or modules thereof) and instead rely on the other controller 204 for the capabilities provided by those components. As another example, the PCF framework module 175 may include its own controller that operates in conjunction with the controller 204. In such a case, the controller of the PCF framework module 175 may be part of the controller 204 or may be separate from (e.g., having many of the same capabilities and functionality) the controller 204.

The controller 204 performs a number of functions that may include receiving or otherwise obtaining data, evaluating data, following protocols 232, running algorithms 233, receiving or otherwise obtaining instructions, and sending instructions. A PCF determination apparatus 140 can have a single controller 204 or multiple controllers 204. When there are multiple controllers 204 of a PCF determination apparatus 140, each controller 204 can operate independently of each other. Alternatively, one or more of the controllers 204 of the PCF determination apparatus 140 can work cooperatively with each other. As yet another alternative, one of the controllers 204 of a PCF determination apparatus 140 can control some or all of one or more other controllers 204 of the PCF determination apparatus 140. Each controller 204 of the PCF determination apparatus 140 can be considered a type of computer device, as discussed below with respect to FIG. 3.

The storage repository 231 of a controller 204 of the PCF determination apparatus 140 may be a persistent storage device (or set of devices) that stores software and data used to assist the controller 204 in communicating with one or more other components of the PCF determination apparatus 140 and/or other components of the system 100 (e.g., a customer system 155 of a customer 150, the network manager 180). In one or more example embodiments, the storage repository 231 stores one or more protocols 232, one or more algorithms 233, and stored data 234.

The protocols 232 of the storage repository 231 may be any procedures (e.g., a series of method steps) and/or other similar operational processes that the control engine 206 of the controller 204 follows based on certain conditions at a point in time. The protocols 232 may include any of a number of communication protocols that are used to send and/or obtain data between the controller 204 and other components of a system (e.g., system 100) or portion thereof (e.g., a customer system 155). Such protocols 232 used for communication may be a time-synchronized protocol. Examples of such time-synchronized protocols may include, but are not limited to, a highway addressable remote transducer (HART) protocol, a WirelessHART protocol, and an International Society of Automation (ISA) 100 protocol. In this way, one or more of the protocols 232 may provide a layer of security to the data transferred within a system or portion thereof (e.g., a customer system 155). Other protocols 232 used for communication may be associated with the use of Wi-Fi, Zigbee, visible light communication (VLC), cellular networking, BLE, UWB, and Bluetooth. One or more of the protocols 232 can be part of the instructions of the PCF determination apparatus 140 (including the PCF framework module 175) delivered to a customer system 155 of a customer 150.

The algorithms 233 may be any formulas, mathematical models, forecasts, simulations, and/or other similar tools that the control engine 206 and/or other component of the controller 204 uses to reach a computational conclusion. For example, one or more algorithms 233 may be used, in conjunction with one or more protocols 232, to assist the controller 204 to receive and interpret a request or instruction from the network manager 180. As another example, one or more algorithms 233 may be used, in conjunction with one or more protocols 232, and based on the selection 196 of an appropriate selection option in a landscape 185, to assist the controller 204 (or portion thereof, such as the organization module 246) to organize some or all of the initial emission-related data 195 received from the network manager 180, one or more sensor devices 160, one or more customers 150, and/or one or more suppliers 151.

As yet another example, when the initial emission-related data 195 received by the PCF determination apparatus 140 is raw or partially processed, one or more algorithms 233 may be used, in conjunction with one or more protocols 232, and based on the selection 196 of an appropriate selection option in a landscape 185, to assist the controller 204 (or portions thereof, such as the data processing module 243) of the PCF determination apparatus 140 to process (e.g., format, filter) or fully process the emission-related data 195 received from one or more customers 150 and/or one or more suppliers 151.

As still another example, one or more algorithms 233 may be used, in conjunction with one or more protocols 232, and based on the selection 196 of an appropriate selection option in a landscape 185, to assist the controller 204 (or portions thereof, such as the organization module 246) of the PCF determination apparatus 140 to organize (e.g., into multiple subsets) the initial emission-related data 195. As yet another example, one or more algorithms 233 may be used, in conjunction with one or more protocols 232, and based on the selection 196 of an appropriate selection option in a landscape 185, to assist the controller 204 (or portions thereof, such as the data processing module 243) of the PCF determination apparatus 140 to generate and present a PCF value 186.

As still another example, one or more algorithms 233 may be used, in conjunction with one or more protocols 232, to assist the controller 204 (or portion thereof, such as the PCF framework module 175) of the PCF determination apparatus 140 to establish a framework by which a PCF value is generated. In such a case, one or more algorithms 233 may be used, in conjunction with one or more protocols 232, to assist the controller 204 (or portion thereof, such as the selection processing module 249 of the PCF framework module 175) of the PCF determination apparatus 140 to evaluate and/or otherwise process selections 196 of various selection options made by one or more users. As yet another example, one or more algorithms 233 may be used, in conjunction with one or more protocols 232, to assist the controller 204 (or portion thereof, such as the data source designation module 245 of the PCF framework module 175) of the PCF determination apparatus 140 to determine the one or more sources from which the initial emission-related data 195 is used in a framework based on one or more of the selections 196.

As still another example, one or more algorithms 233 may be used, in conjunction with one or more protocols 232, to assist the controller 204 (or portion thereof, such as the guideline verification module 247 of the PCF framework module 175) of the PCF determination apparatus 140 to identify one or more applicable guidelines that apply to a selection 196 of a selection option and determine whether the one or more applicable guidelines is followed based on the selection 196. As yet another example, one or more algorithms 233 may be used, in conjunction with one or more protocols 232, to assist the controller 204 (or portion thereof, such as the landscape maintenance module 253 of the PCF framework module 175) of the PCF determination apparatus 140 to manage the current landscape in development and/or some or all of the landscapes that had been previously established or modified to generate one or more frameworks. The control engine 206 of the controller 204 may perform any of a number of other functions, some of which are described below.

Stored data 234 may be any data associated with the other components (e.g., a customer system 155, the network manager 180) of a system (e.g., system 100), relevant standards, relevant laws and regulations, PCF values, prior selections 196, prior frameworks, initial emission-related data 195, organized data, guidelines, hierarchies, categorizations of data, selection options, threshold values, tables, results of previously run or calculated algorithms 233, updates to protocols 232, user preferences, and/or any other suitable data. Such data may be any type of data, including but not limited to historical data, present data, and future data (e.g., forecasts). The stored data 234 may be associated with some measurement of time derived, for example, from the timer 235.

Examples of a storage repository 231 may include, but are not limited to, a database (or a number of databases), a file system, cloud-based storage, a hard drive, flash memory, some other form of solid-state data storage, or any suitable combination thereof. The storage repository 231 may be located on multiple physical machines, each storing all or a portion of the protocols 232, the algorithms 233, and/or the stored data 234 according to some example embodiments. Each storage unit or device may be physically located in the same or in a different geographic location.

The storage repository 231 may be operatively connected to the control engine 206. In one or more example embodiments, the control engine 206 includes functionality to communicate with other components (if any) of the PCF determination apparatus 140 (including the PCF framework module 175) and/or the other components (e.g., another component of the emission system 170, the network manager 180, the customer systems 155, another PCF determination apparatus 140 (including another PCF framework module), other parts of the emission system 170) of the system 100. More specifically, the control engine 206 sends information to and/or obtains information from the storage repository 231 in order to communicate with the various components of a PCF determination apparatus 140 (including the PCF framework module 175) and/or the various components of the system 100. As discussed below, the storage repository 231 may also be operatively connected to the communication module 207 in certain example embodiments.

In certain example embodiments, the control engine 206 of the controller 204 controls the operation of one or more other components (e.g., the communication module 207, the timer 235, the transceiver 224) of the controller 204. For example, the control engine 206 may activate the communication module 207 when the communication module 207 is in “sleep” mode and when the communication module 207 is needed to send data obtained from another component (e.g., a customer system 155) and/or another controller (e.g., a controller 204 of another PCF determination apparatus 140) in the system 100. In addition, the control engine 206 of the controller 204 may control the operation of one or more other components (e.g., another part of the emission system 170, a controller 204 of another PCF determination apparatus 140), or portions thereof, of the system 100.

In certain example embodiments, the control engine 206 of the controller 204 of the PCF determination apparatus 140, using one or more algorithms 233, one or more protocols 232, stored data 234, and the selection processing module 249 of the PCF framework module 175, may be configured to perform one or more of a number of checks or validations with respect to a selection 196 of a selection option of a landscape 185 that is received by the PCF framework module 175 of the PCF determination apparatus 140 of the emission system 170. For example, the control engine 206 may use the selection processing module 249 of the PCF framework module 175 to verify that a selection 196 of a selection option falls within a set of guidelines that currently apply to the selection option (e.g., the processing and/or organization of initial emission-related data 195 or some processed version thereof). Examples of such guidelines may include, but are not limited to, the initial emission-related data 195 required for the selection 196, the one or more sources from which such initial emission-related data 195 may be obtained, whether such one or more sources of the initial emission-related data 195 are available to provide the initial emission-related data 195, whether the initial emission-related data 195 is reliable, whether the user submitted the selection 196 has the authority to do so, and whether the selection 196 contradicts a previous selection 196 made by a different user having a higher level authority relative to the current user.

In certain example embodiments, the control engine 206 of the controller 204 of the PCF determination apparatus 140, using one or more algorithms 233, one or more protocols 232, stored data 234, and the data source designation module 245 of the PCF framework module 175, may be configured to designate a source (or multiple sources) of the initial emission-related data 195 (or a processed version thereof) based on one or more selections 196 made among various selection options. Such a designation may be based on the verification discussed above with respect to the set of guidelines that apply to the initial emission-related data 195. Such a designation may be done in real time so that immediate feedback may be provided to a user in the event that there are issues or unusual circumstances (e.g., there is no actual initial emission-related data 195 available from a customer 150, a supplier 151, or a sensor device 160, and so the initial emission-related data 195 is to be provided by a third-party source (e.g., via the network manager 180) as an approximation) based on one or more selections 196 made among various selection options made by the user.

In certain example embodiments, the control engine 206 of the controller 204 of the PCF determination apparatus 140, using one or more algorithms 233, one or more protocols 232, stored data 234, and the guideline verification module 247 of the PCF framework module 175, may be configured to verify that a selection 196 of a selection option falls within one or more guidelines that apply to the selection 196. For example, the control engine 206, using the guideline verification module 247, may determine whether a selection 196 of a selection option meets one or more guidelines by falling within a range of parameters (e.g., dates, business entity, sources of initial emission-related data 195, user authority, hierarchical resolution of conflicts).

As another example, the control engine 206, using the guideline verification module 247, may analyze (e.g., verify that an applicable guideline is followed) a selection 196 in the form of a link (a form of selection option) between two prior selections 196 in the form of processing steps (other forms of selection options) for data (e.g., initial emission-related data 195, partially processed initial emission-related data 195) with the ultimate goal of generating a PCF value 186. For instance, the control engine 206, using the guideline verification module 247, may verify that the output of one prior selection 196 of a selection option (e.g., initial emission-related data 195 organized after being received from one or more sources) may be used directly as an input for another prior selection 196 of a selection option (e.g., formatting the organized initial emission-related data 195) based on a current selection 196 by a user of a selection option to link the two as part of a process flow.

In certain example embodiments, the control engine 206 of the controller 204 of the PCF determination apparatus 140, using one or more algorithms 233, one or more protocols 232, stored data 234, and the landscape maintenance module 253 of the PCF framework module 175, may be configured to actively manage each landscape 185 that is subject to one or more selections 196 of various selection options by one or more users. A landscape 185 can be derived entirely by a user. Alternatively, a landscape 185 may be a modified version of a previously-generated framework.

Ultimately, when all of the selections 196 are made among the various selection options within one or more landscapes 185 to set the framework, the control engine 206 of the controller 204 of the PCF determination apparatus 140 may use the framework (part of stored data 234), which is established by one or more users and validated by the PCF framework module 175, while also using one or more protocols 232 and/or one or more algorithms 233, to generate a PCF value 186. The control engine 206 of the controller 204 of the PCF determination apparatus 140 may then present, using the communication module 207 and one or more protocols 232, the PCF value 186 to the customer 150 and/or some other entity at the direction of the customer 150.

In this way, the control engine 206 of the controller 204, in conjunction with the PCF framework module 175, may be configured to help establish, based on the current framework (e.g., just created, selected from a history of frameworks), in real time and with a continual ability to be modified by a user based in part on real-time feedback provided by the PCF framework module 175, how a PCF value 186 is generated using some or all of the initial emission-related data 195. One or more other components or portions of the PCF determination apparatus 140 may be used to enact one or more of the selections 196 from among the selection options of the landscapes 185 that make up the framework. For example, when the first selection 196 in a process flow that makes up a framework is for a selection option to organize the initial emission-related data 195, the control engine 206 of the controller 204 of the PCF determination apparatus 140, using the organization module 246 and one or more protocols 232, may organize the initial emission-related data 195.

The control engine 206 may generate and process data associated with control, communication, and/or other signals sent to and/or obtained from another component (e.g., another part of the emission system 170, a controller 204 of another PCF determination apparatus 140, the network manager 180, a customer system 155) of the system 100. In certain embodiments, the control engine 206 of the controller 204 may communicate with one or more components of a system external to the system 100. For example, the control engine 206 may interact with a regulatory agency and/or compliance group to receive the latest regulations, requirements, and other information associated with PCFs. As another example, the control engine 206 may interact with an industry group to receive representative data when particular industry emission-related data 195 is not available from one of the sources in the system 100.

In certain example embodiments, the control engine 206 may include an interface that enables the control engine 206 to communicate with another component (e.g., another part of the emission system 170, another controller 204 of another PCF determination apparatus 140, the network manager 180, a customer system 155) of the system 100. For example, if a controller 204 of another PCF determination apparatus 140 operates under IEC Standard 62386, then the controller 204 of the other PCF determination apparatus 140 may have a serial communication interface that will transfer data to the controller 204. Such an interface may operate in conjunction with, or independently of, the protocols 232 used to communicate between the controller 204 and the other components of the system 100.

The control engine 206 (or other components of the controller 204) may also include one or more hardware components and/or software elements to perform its functions. Such components may include, but are not limited to, a universal asynchronous receiver/transmitter (UART), a serial peripheral interface (SPI), a direct-attached capacity (DAC) storage device, an analog-to-digital converter, an inter-integrated circuit (I2C), and a pulse width modulator (PWM).

In certain example embodiments, the data processing module 243 of the controller 204 of the PCF determination apparatus 140 may be configured to process (e.g., filter, format, generate averages) initial emission-related data 195. Such initial emission-related data 195 may be received by the PCF determination apparatus 140 from any of a number of sources, including but not limited to the network manager 180, a customer system 155 of a customer 150, and a supplier system 152 of a supplier 151. The data processing module 243 may use one or more algorithms 233, one or more protocols 232, and/or stored data 234 to organize and/or process (e.g., format, filter) the initial emission-related data 195.

In certain example embodiments, the organization module 246 of the controller 204 of the PCF determination apparatus 140 may be configured to organize (e.g., by date, by range of dates, by source, by sensor device 160, by business unit, into multiple subsets, into multiple stages) the initial emission-related data 195. In addition, or in the alternative, the organization module 246 of the controller 204 of the PCF determination apparatus 140 may be configured to categorize and/or recategorize one or more of the subsets of organized data. For example, when the PCF determination apparatus 140 receives initial emission-related data 195 and categorizes the initial emission-related data 195 into groups, the organization module 246 of the controller 204 of the PCF determination apparatus 140 may be configured to categorize each of the resulting groups of organized data as “draft” or “original” or “approved” or “verified” or some other designation or status. The organization module 246 may use one or more algorithms 233, one or more protocols 232, and/or stored data 234 to perform its various functions.

The PCF framework module 175 of the controller 204 may generally be configured to establish a framework that may be used to generate a PCF value 186. The PCF framework module 175 may include one or more of a number of components. For example, in this case, the PCF framework module 175 includes the selection processing module 249, the guideline verification module 247, the data source designation module 245, and the landscape maintenance module 253. As discussed above, the various modules of the PCF framework module 175 are controlled in this case by the control engine 206. In alternative embodiments, the PCF framework module 175 may additionally or alternatively include its own controller (or portions thereof).

The selection processing module 249 of the PCF framework module 175 of the controller 204 may be configured to perform one or more of a number of checks or validations (e.g., using one or more guidelines, using one or more protocols 232) with respect to a selection 196 of a selection option of a landscape 185 that is received by the PCF framework module 175 of the PCF determination apparatus 140 of the emission system 170. In this way, in real time, the selection processing module 249 of the PCF framework module 175 may determine whether a selection 196 of a selection option, made by a user in an attempt to develop a framework from a landscape 185 so that a PCF value may be generated, is valid and may be used.

The selection processing module 249 may also be configured to determine whether the user making the selection 196 of a selection option is authorized to do so and/or how to resolve issues (e.g., using a hierarchy) that arise when a selection 196 conflicts with a prior selection 196 in the landscape 185. In some cases, the selection processing module 249 may additionally or alternatively be configured to format, filter, and/or otherwise process a selection 196 for use in generating a PCF value 186 within the PCF framework. For example, if a selection 196 is or includes a value or group of values, the selection processing module 249 may be configured to, in real time, average, perform a unit conversion, validate, and/or otherwise process the value or group of values. As another example, if a selection 196 is or includes a facility, the selection processing module 249 may be configured to, in real time, confirm that the facility falls within the scope of facilities that contribute to generating a PCF value 186, was operational during the time frame for which a PCF value 186 is being generated, has not already been considered in another portion of the framework being assembled to generate a PCF value 186, etc.

The guideline verification module 247 of the PCF framework module 175 of the controller 204 may be configured to verify that a selection 196 of a selection option falls within one or more guidelines that apply to the selection 196 and/or the selection option. For example, the guideline verification module 247 may determine whether a selection 196 meets one or more guidelines by falling within a range of parameters (e.g., dates, business entity, sources of initial emission-related data 195, user authority, hierarchical resolution of conflicts). As another example, the guideline verification module 247 may analyze (e.g., verify that an applicable guideline is followed) a selection 196 of a selection option in the form of a link between two prior selections 196 in the form of processing steps for data (e.g., initial emission-related data 195, partially processed initial emission-related data 195) with the ultimate goal of generating a PCF value 186. For instance, the guideline verification module 247 may verify that the output of one prior selection 196 (e.g., initial emission-related data 195 organized after being received from one or more sources) may be used directly as an input for another prior selection 196 (e.g., formatting the organized initial emission-related data 195) based on a current selection 196 by a user linking the two as part of a process flow.

The guideline verification module 247 may be configured to, in real time, identify all applicable guidelines that apply to a selection 196, locate all applicable guidelines (e.g., from within the stored data 234 of the storage repository 231, from a third party outside the emission system 170), evaluate each selection 196 against each applicable guideline, communicate whether a selection 196 falls within applicable guidelines, identify modifications and/or alternatives to a selection 196 that does not fall within applicable guidelines, and/or communicate modifications and/or alternatives to a selection 196 so that the modified or alternative selection 196 falls within applicable guidelines.

The data source designation module 245 of the PCF framework module 175 of the controller 204 may be configured to designate a source (or multiple sources) of the initial emission-related data 195 (or a processed version thereof) required for a selection 196. Such a designation may be based on the validation performed by the selection processing module 249, as discussed above. Such a designation may be done in real time so that immediate feedback may be provided to a user in the event that there are issues or unusual circumstances (e.g., there is no actual initial emission-related data 195 available from a customer 150, a supplier 151, or a sensor device 160, and so the initial emission-related data 195 is to be provided by a third-party source (e.g., via the network manager 180) as an approximation) as a result of the selection 196 of a selection option made by the user.

The landscape maintenance module 253 of the PCF framework module 175 of the controller 204 may be configured to actively manage each landscape 185 that is subject to one or more selections 196 among various selection options made by one or more users. For example, the landscape maintenance module 253 may track and aggregate all of the selections 196 made in a landscape 185 and make updates in real time as selections 196 are made and/or modified by a user. A landscape 185 can be derived entirely by a user. Alternatively, a landscape 185 may be a modified version of a previously-generated framework.

In certain example embodiments, the landscape maintenance module 253 may also be configured to present a landscape 185 in its current form during the process when a framework is established. In such cases, the landscape maintenance module 253 may present an initial landscape 185 when the process of establishing a framework is beginning. Subsequently, as each selection 196 of a selection option is made by a user and accepted after being evaluated by other components (e.g., the selection processing module 249, the guideline verification module 247) of the PCF framework module 175, the landscape maintenance module 253 may present a landscape 185 that includes such selections 196 and/or feedback on selections 196 that are not accepted.

The communication module 207 of the controller 204 determines and implements the communication protocol (e.g., from the protocols 232 of the storage repository 231) that is used when the control engine 206 communicates with (e.g., sends signals to, obtains signals from) the other components (e.g., the network manager 180, a customer system 155, other components of the emission system 170, another component of the PCF determination apparatus 140) of the system 100. In some cases, the communication module 207 accesses the stored data 234 to determine which communication protocol is used to communicate with another component of the system 100. In addition, the communication module 207 may identify and/or interpret the communication protocol of a communication obtained by the controller 204 so that the control engine 206 may interpret the communication. The communication module 207 may also provide one or more of a number of other services with respect to data sent from and obtained by the controller 204. Such services may include, but are not limited to, data packet routing information and procedures to follow in the event of data interruption.

The timer 235 of the controller 204 may track clock time, intervals of time, an amount of time, and/or any other measure of time. The timer 235 may also count the number of occurrences of an event, whether with or without respect to time. Alternatively, the control engine 206 may perform a counting function. The timer 235 is able to track multiple time measurements and/or count multiple occurrences concurrently. The timer 235 may track time periods based on an Instruction obtained from the control engine 206, based on an instruction obtained from the network manager 180, based on an instruction programmed in the software for the controller 204, based on some other condition (e.g., the occurrence of an event) or from some other component, or from any combination thereof. In certain example embodiments, the timer 235 may provide a time stamp for each packet of data obtained from another component (e.g., a sensor device) of the system 100.

The power module 230 of the controller 204 is configured to obtain power from a power supply (e.g., AC mains, a battery) and manipulate (e.g., transforms, rectifies, inverts) that power to provide the manipulated power to one or more other components (e.g., the timer 235, the control engine 206) of the controller 204. The power module 230 may also be configured so that the manipulated power is of a type (e.g., alternating current, direct current) and level (e.g., 12V, 24V, 120V) that may be used by the other components of the controller 204.

The power module 230 may include one or more of a number of single or multiple discrete components (e.g., transistor, diode, resistor, transformer) and/or a microprocessor. The power module 230 may include a printed circuit board, upon which the microprocessor and/or one or more discrete components are positioned. In addition, or in the alternative, the power module 230 may be a source of power in itself to provide signals to the other components of the controller 204. For example, the power module 230 may be or include an energy storage device (e.g., a battery). As another example, the power module 230 may be or include a localized photovoltaic power system.

The hardware processor 221 of the controller 204 executes software, algorithms (e.g., algorithms 233), and firmware in accordance with one or more example embodiments. Specifically, the hardware processor 221 may execute software on the control engine 206 or any other portion of the controller 204, as well as software used by the customer systems 155, the network manager 180, and/or other components of the system 100. The hardware processor 221 may be an integrated circuit, a central processing unit, a multi-core processing chip, SoC, a multi-chip module including multiple multi-core processing chips, or other hardware processor in one or more example embodiments. The hardware processor 221 may be known by other names, including but not limited to a computer processor, a microprocessor, and a multi-core processor.

In one or more example embodiments, the hardware processor 221 executes software instructions stored in memory 222. The memory 222 includes one or more cache memories, main memory, and/or any other suitable type of memory. The memory 222 may include volatile and/or non-volatile memory. The memory 222 may be discretely located within the controller 204 relative to the hardware processor 221. In certain configurations, the memory 222 may be integrated with the hardware processor 221.

In certain example embodiments, the controller 204 does not include a hardware processor 221. In such a case, the controller 204 may include, as an example, one or more field programmable gate arrays (FPGA), one or more insulated-gate bipolar transistors (IGBTs), and/or one or more integrated circuits (ICs). Using FPGAs, IGBTs, ICs, and/or other similar devices known in the art allows the controller 204 (or portions thereof) to be programmable and function according to certain logic rules and thresholds without the use of a hardware processor. Alternatively, FPGAs, IGBTs, ICs, and/or similar devices may be used in conjunction with one or more hardware processors 221.

The transceiver 224 of the controller 204 may send and/or obtain control and/or communication signals. Specifically, the transceiver 224 may be used to transfer data between the controller 204 and the other components (e.g., PCF framework module 175) of the PCF determination apparatus 140 and the other components (e.g., the network manager 180, a customer system 155, another PCF determination apparatus 140) of the system 100. The transceiver 224 may use wired and/or wireless technology. The transceiver 224 may be configured in such a way that the control and/or communication signals sent and/or obtained by the transceiver 224 may be obtained and/or sent by another transceiver that is part of another component (e.g., the network manager 180, a customer system 155, another component of the emission system 170, another PCF determination apparatus 140) of the system 100. The transceiver 224 may send and/or obtain any of a number of signal types, including but not limited to radio frequency signals.

When the transceiver 224 uses wireless technology, any type of wireless technology may be used by the transceiver 224 in sending and obtaining signals. Such wireless technology may include, but is not limited to, Wi-Fi, Zigbee, VLC, cellular networking, BLE, UWB, and Bluetooth. The transceiver 224 may use one or more of any number of suitable communication protocols (e.g., ISA100, HART) when sending and/or obtaining signals.

Optionally, in one or more example embodiments, the security module 223 secures interactions between the controller 204 and the other components (e.g., the network manager 180, a customer system 155, another component of the emission system 170, another PCF determination apparatus 140) of the system 100. More specifically, the security module 223 authenticates communication from software based on security keys verifying the identity of the source of the communication. For example, user software may be associated with a security key enabling the software of a customer system 155 to interact with the controller 204. Further, the security module 223 may restrict receipt of information, requests for information, and/or access to information.

The other components (if any) of the PCF determination apparatus 140 and the other components (e.g., the network manager 180, a customer system 155, another component of the emission system 170, another PCF determination apparatus 140) of the system 100 may interact with the controller 204 of the PCF determination apparatus 140 using the application interface 226. Specifically, the application interface 226 of the controller 204 obtains communications (e.g., information, data, instructions, updates to firmware, updates to software) from and sends communications (e.g., information, data, instructions, updates to firmware, updates to software) to the other components of the PCF determination apparatus 140 and/or the other components (e.g., the network manager 180, a customer system 155, another PCF determination apparatus 140) of the system 100.

Examples of an application interface 226 may be or include, but are not limited to, an application programming interface, a web service, a data protocol adapter, some other hardware and/or software, or any suitable combination thereof. Similarly, other components of the PCF determination apparatus 140 and the other components (e.g., the network manager 180, a customer system 155, another PCF determination apparatus 140) of the system 100 may include an interface (similar to the application interface 226 of the controller 204) to obtain communications from and send communications to the controller 204 in certain example embodiments.

FIG. 3 illustrates one embodiment of a computing device 318 that implements one or more of the various techniques described herein, and which is representative, in whole or in part, of the elements described herein pursuant to certain example embodiments. For example, a controller 204 (including components thereof, such as a control engine 206, a hardware processor 221, a storage repository 231, a power module 230, and a transceiver 224) may be considered a computing device 318. Computing device 318 is one example of a computing device and is not intended to suggest any limitation as to scope of use or functionality of the computing device and/or its possible architectures. Neither should the computing device 318 be interpreted as having any dependency or requirement relating to any one or combination of components illustrated in the example computing device 318.

The computing device 318 includes one or more processors or processing units 314, one or more memory/storage components 315, one or more input/output (I/O) devices 316, and a bus 317 that allows the various components and devices to communicate with one another. The bus 317 represents one or more of any of several types of bus structures, including a memory bus or memory controller, a peripheral bus, an accelerated graphics port, and a processor or local bus using any of a variety of bus architectures. The bus 317 may include wired and/or wireless buses.

The memory/storage component 315 represents one or more computer storage media. The memory/storage component 315 includes volatile media (such as random access memory (RAM)) and/or nonvolatile media (such as read only memory (ROM), flash memory, optical disks, magnetic disks, and so forth). The memory/storage component 315 includes fixed media (e.g., RAM, ROM, a fixed hard drive, etc.) as well as removable media (e.g., a flash memory drive, a removable hard drive, an optical disk, and so forth).

One or more I/O devices 316 allow a customer 150 to enter commands and information to the computing device 318, and also allow information to be presented to the customer 150 (including an associated customer system 155) and/or other components or devices. Examples of input devices 316 include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 318 (also sometimes called a computer system 318) is connected to a network (not shown) (e.g., a LAN, a WAN such as the Internet, cloud, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer system 318 includes at least the minimal processing, input, and/or output means necessary to practice one or more embodiments.

Further, those skilled in the art will appreciate that one or more elements of the aforementioned computer device 318 is located at a remote location and connected to the other elements over a network in certain example embodiments. Further, one or more embodiments can be implemented on a distributed system having one or more nodes, where each portion of the implementation (e.g., a PCF determination apparatus 140, a PCF framework module 175) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

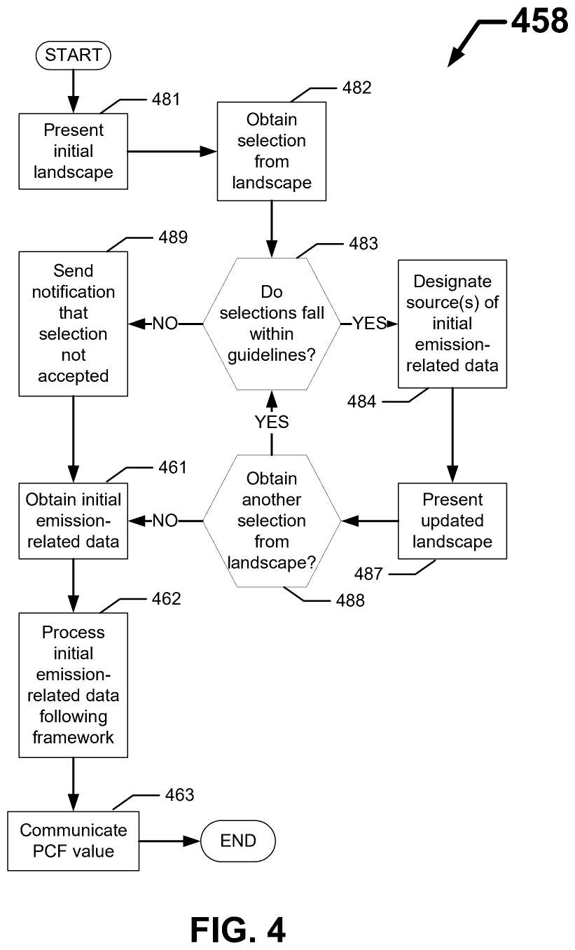

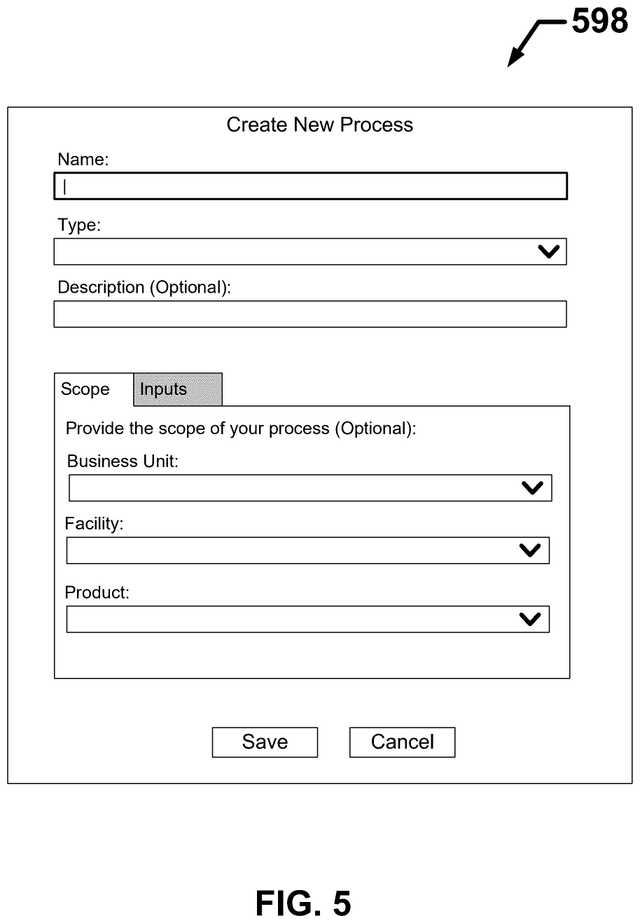

FIG. 4 shows a flowchart 458 of a method for establishing a PCF framework to determine a PCF value 186 for a corporate entity (e.g., a customer 150) according to certain example embodiments. FIGS. 5 through XX show examples of screenshots that may be presented during implementation of the method of FIG. 4. While the various steps in this flowchart 458 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order.

In addition, a person of ordinary skill in the art will appreciate that additional steps not shown in FIG. 4 may be included in performing this method. Accordingly, the specific arrangement of steps should not be construed as limiting the scope. Further, a particular computing device, such as the computing device 318 discussed above with respect to FIG. 3, may be used to perform or facilitate performance of one or more of the steps (or portions thereof) for the method shown in FIG. 4 in certain example embodiments. Any of the functions (or portions thereof) performed below by a controller 204 may involve the use of one or more protocols 232, one or more algorithms 233, and/or stored data 234 stored in a storage repository 231. In some cases, one or more of the various steps in the method of FIG. 4 can be performed automatically, as by the controller 204 of the PCF determination apparatus 140.

The method shown in FIG. 4 is merely an example that may be performed by using an example system described herein. In other words, systems for establishing a PCF framework to determine a PCF value 186 for a corporate entity may perform other functions using other methods in addition to and/or aside from those shown in FIG. 4. Referring to the description above with respect to FIGS. 1 through 3, the method shown in the flowchart 458 of FIG. 4 begins at the START step and proceeds to step 481, where an initial landscape 185 is presented. The initial landscape 185 may be presented by the landscape maintenance module 253 of the PCF framework module 175 of the controller 204 of the PCF determination apparatus 140. The initial landscape 185 may be presented to a user on a user system (e.g., a customer system 155, a supplier system 152).

The landscape maintenance module 253 may generate and present the initial landscape 185 using the control engine 206, one or more protocols 232, one or more algorithms 233, stored data 234, the communication module 207, and/or the application interface 226 of the controller 204 of the PCF determination apparatus 140. The initial landscape 185 may be presented in any of a number of different formats using any of a number of different media. When the initial landscape 185 is presented, it may be interactive (e.g., via a user interface) with a user. As discussed above, a user may be a customer 150, a supplier 151, or some other person or entity with an interest in the PCF value 186.

In some cases, before the initial landscape 185 is presented, some preliminary information is obtained by the controller 204 of the PCF determination apparatus 140. FIG. 5 shows an example of a screenshot 598 in which an initial screening is performed. Specifically, the screenshot 598 of FIG. 5 includes a window with several editable fields. In the top field, a user may enter (e.g., type) the name of the process (one selection option), which will form the eventual framework. The next field down (another selection option) in the screenshot 598 is the type of process, which in this case is selectable from a list in a dropdown menu. The next field down (yet another selection option) in the screenshot 598 is an optional description (freeform typing in this case). The next field down in the screenshot 598 is an optional selection option between scope and inputs. Under the scope tab, as shown in the screenshot 598 of FIG. 5, are a dropdown menu (another selection option) for the business unit, a dropdown menu (another selection option) for the facility, and a dropdown menu (another selection option) for the product.

In some cases, the particular user interacting with the initial landscape 185 is identified. For example, the user may present login credentials to identify the user before the initial landscape 185 is presented. As another example, the user may undergo a biometric scan to identify the user before the initial landscape 185 is presented. In this way, the authority and permissions of the user, retrieved from the stored data 234, may be used by the landscape maintenance module 253 to tailor (e.g., in terms of format, by activating and/or deactivating certain fields) the initial landscape 185. Once the preliminary screening is performed, the initial landscape 185 may be presented.

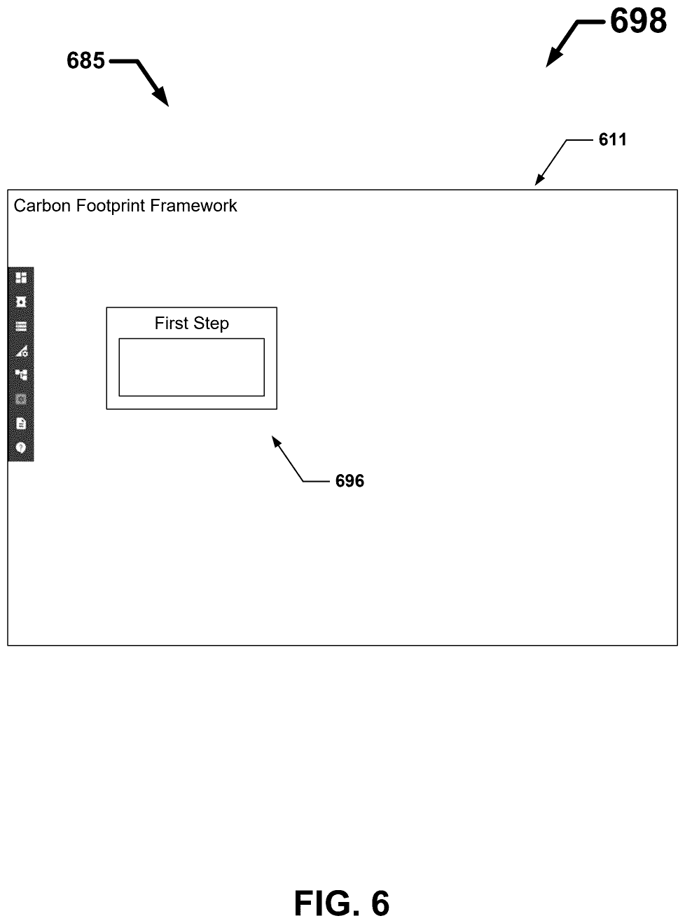

FIG. 6 shows an example of a screenshot 698 in which an iteration 611 of the initial landscape 685 is presented. In alternative embodiments, rather than being considered an iteration 611 of the initial landscape 685, the iteration 611 of FIG. 6 may be considered a separate landscape that is related to the landscape 685. In some cases, the initial landscape 685 has only a single iteration rather than multiple iterations. The screenshot 698 also shows a selection 696 (substantially the same as the selections 196 discussed above) among various selection options resulting in the start of a First Step in the process of generating a PCF value.

In step 482, one or more selections 196 (e.g., selection 696) from the initial landscape 185 (e.g., initial landscape 685) are obtained. As used herein, the term “obtaining” may include receiving, retrieving, accessing, generating, etc. or any other manner of obtaining a selection 196 and/or other information associated with establishing a framework. Each selection 196 may be obtained from one or more users in the form of one or more customers 150 (via one or more customer systems 155) and/or one or more suppliers 151 (via one or more supplier systems 152). A selection 196 of a selection option may be obtained by a controller 204 (or portion thereof, such as the landscape maintenance module 253) of the PCF landscape module 175 of the PCF determination apparatus 140 of an emission system 170 using the communication module 207 and/or the application interface 226 of the controller 204 of the PCF determination apparatus 140.

In some cases, a selection 196 from among selection options within an iteration (e.g., iteration 611) of the initial landscape 685 may be an iterative process, taking multiple steps (e.g., multiple iterations of the initial landscape 685, multiple back-and-forths within the same iteration 611) before the selection 196 is complete. In this example, the iteration 611 of the initial landscape 685 of the screenshot 698 shows the selection 696 in the form of a block in a flow diagram labeled “First Step”. When a user selects the block (one of the selection options), the selection 696 (or first part of the selection 696) is received by the landscape maintenance module 253.

Generally, when a selection 196 (or the part of a selection 196) of a selection option is received, the selection processing module 249 of the PCF framework module 175 of the controller 204 may be configured to perform one or more of a number of checks or validations (e.g., using one or more guidelines, using one or more protocols 232) with respect to the selection 196. In this way, in real time, the selection processing module 249 of the PCF framework module 175 may determine whether the selection 196 is valid and may be used. The selection processing module 249 may also be configured to determine whether the user making the selection 196 of the selection option is authorized to do so and/or how to resolve issues (e.g., using a hierarchy) that arise when the selection 196 conflicts with a prior selection 196 in the landscape 185.

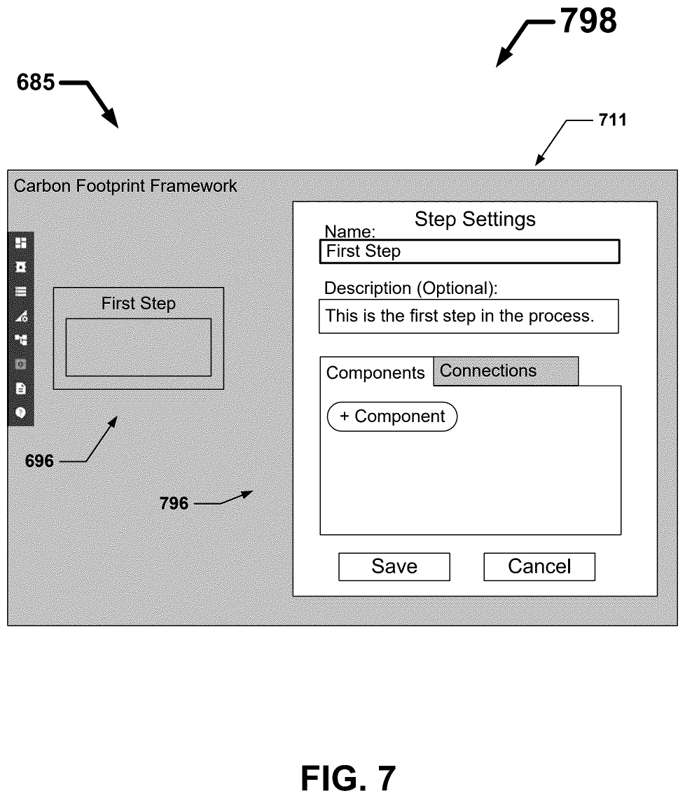

In response, the landscape maintenance module 253 generates another iteration (e.g., iteration 711) of the landscape 685 to present a dialogue box, as shown in the screenshot 798 of FIG. 7. In the dialogue box shown in the next iteration 711 of the initial landscape 685 shown in the screenshot 798, there are fields that allow for freeform entry of the name and optional description of the first step. The entry in each field (forms of selection options) by a user may be considered a separate selection 796 or part of an overall selection 796 for the iteration 711. In addition, the dialogue box shown in the screenshot 798 of FIG. 7 allows for selection 796 of “components” or “connections” (forms of selection options). In this case, “components” is the selection 796 made by the user, which may be considered a separate selection 796 within the iteration 711 of the initial landscape 685 or part of the overall selection 796 for the iteration 711 of the initial landscape 685.

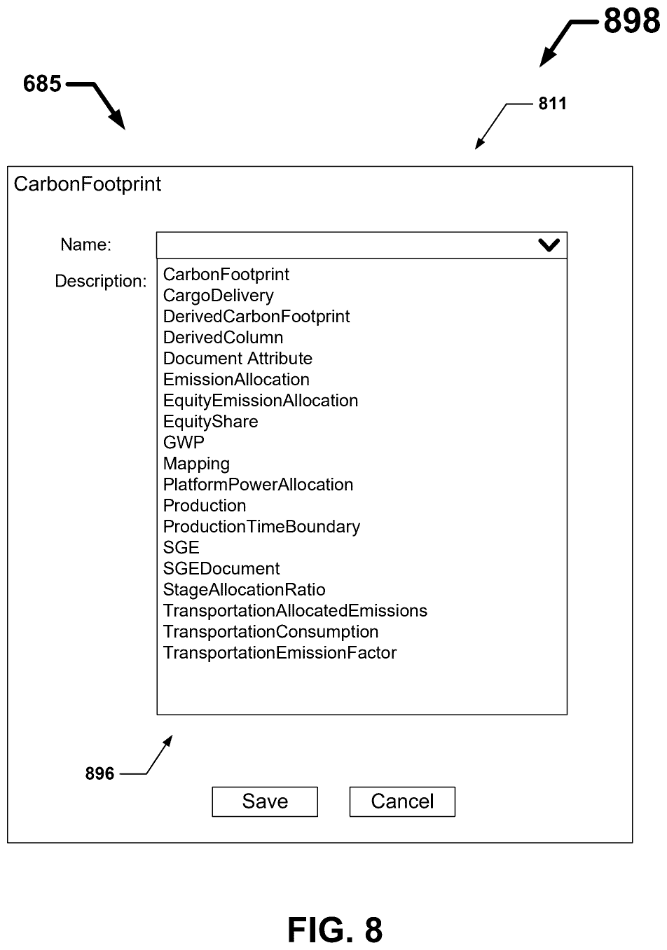

When a user makes a selection 796 of the “components” selection option from the iteration 711 of the initial landscape 685 of FIG. 7, such selection 796 is received by the landscape maintenance module 253. In response, the landscape maintenance module 253 generates another iteration 811 of the initial landscape 685 to present another dialogue box, as shown in the screenshot 898 of FIG. 8. Specifically, FIG. 8 shows a screenshot 898 of a dialogue box for selecting a name of the component from a dropdown menu and an optional description, which may be entered as freeform text.

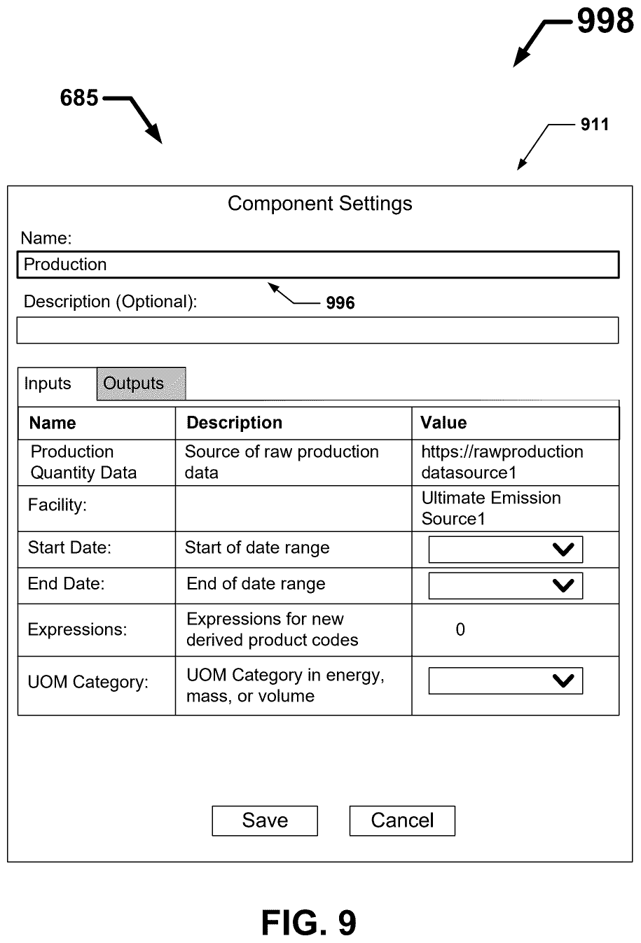

When a user makes a selection 896 of one of the selection options (e.g., “DocumentAttribute”) from the dropdown menu in FIG. 8, such selection 896 for the iteration 811 of the initial landscape 685 is received by the landscape maintenance module 253. In response, the landscape maintenance module 253 generates another iteration 911 of the initial landscape 685 to present another dialogue box, as shown in the screenshot 998 of FIG. 9. Specifically, FIG. 9 shows a screenshot 998 of a dialogue box (having a number of selection options) for adjusting the settings of the component selected in FIG. 8. In this case, the dialogue box presented by the landscape maintenance module 253 includes a freeform field (a selection option) for the name of the component, an optional freeform field (a selection option) for a description of the component, and separate tabs (selection options) for “inputs” and “outputs” of the component. Each of these fields may represent a separate selection 996 or part of an overall selection 996 for the iteration 911.

The screenshot 998 of FIG. 9 shows that a selection 996 of the “inputs” tab selection option has been made by a user. As a result, the screenshot 998 showing the iteration 911 of the initial landscape 685 includes fields (selection options) for production quantity data, facility, start date, end date, expressions, and UCM category. The screenshot 998 also includes a description of each field. Some of the fields (selection options) allow for user interaction (e.g., selection options from dropdown menus), while other fields (selection options) are inactive, merely providing information without an opportunity for the user to make a selection 996 for that field. The landscape maintenance module 253 may be configured to control which fields (selection options) are active and which fields (selection options) are inactive on this iteration 911 of the landscape 685 (or any other iteration of any of the landscapes for a framework) based on one or more of a number of factors (e.g., a hierarchy, authorizations, conflict resolution, confidentiality) using one or more protocols 232. In this example, when the selections 996 in the iteration 911 of the landscape 685 shown in FIG. 9 are obtained, the initial landscape 685 is complete.

In step 483, a determination is made as to whether all of the one or more selections 196 (e.g., selection 696, selection 996) among the selection options for the initial landscape 685 fall within guidelines. The determination as to whether the one or more selections 196 among the selection options for the initial landscape 685 fall within guidelines may be made by the guideline verification module 247 of the PCF framework module 175 of the controller 204 using the control engine 206, one or more protocols 232, one or more algorithms 233, and/or stored data 234. The guidelines being considered may apply specifically to the one or more selections 196, the user, and/or any other factors related to each of the selections 196 being considered. For example, the guideline verification module 247 may determine whether a selection 196 falls within a range of parameters (e.g., dates, business entity, sources of initial emission-related data 195, user authority, hierarchical resolution of conflicts).

In certain example embodiments, the guideline verification module 247 of the PCF framework module 175 of the controller 204 may be configured to determine, in real time, upon receiving a selection 196, which one or more guidelines are applicable for evaluating the selection 196. In some cases, a guideline used to evaluate a selection 196 is within the stored data 234 on the storage repository 231. In such cases, the guideline verification module 247 of the PCF framework module 175 may be configured to look up and utilize, in real time, the applicable guideline in the storage repository 231 to evaluate a selection 196. In other cases, a guideline required to evaluate a selection 196 is not stored in the storage repository 231. In such cases, the guideline verification module 247 of the PCF framework module 175 may be configured to, in real time, identify what one or more guidelines are needed to evaluate a selection 196, identify one or more reliable third party sources from which the one or more guidelines may be obtained, retrieve the one or more guidelines from the one or more reliable third party sources, and utilize the one or more guidelines to evaluate a selection 196.

In some cases, the information required to determine whether a selection 196 falls within a guideline is within the stored data 234 on the storage repository 231. In such cases, the guideline verification module 247 of the PCF framework module 175 may be configured to look up and utilize, in real time, the information in the storage repository 231 to determine if a selection 196 falls within an applicable guideline. In other cases, the information required to determine whether a selection 196 falls within a guideline is not stored in the storage repository 231. In such cases, the guideline verification module 247 of the PCF framework module 175 may be configured to, in real time, identify what information is needed to evaluate the selection 196 relative to a guideline, identify a reliable third party source from which the information may be obtained, retrieve the information from the reliable third party source, and utilize the information to determine if a selection 196 falls within an applicable guideline.

In addition to evaluating a selection 196 with respect to one or more applicable guidelines, the guideline verification module 247 of the PCF framework module 175 may be configured to suggest, in real time, changes and/or alternatives to a selection 196 so that an amended or new subsequent selection 196 may fall within all applicable guidelines. For example, if the guideline verification module 247 of the PCF framework module 175 determines that a selection 196 falls outside one or more applicable guidelines, the PCF framework module 175 may be configured to communicate, in real time, the reason that the selection 196 falls outside of one or more of the applicable guidelines. In such a case, the guideline verification module 247 of the PCF framework module 175 may additionally or alternatively identify, in real time, a deficiency with the selection 196 and communicate, in real time, suggestions as to how the selection 196 may be altered so that the modified selection 196 falls within applicable guidelines.

In addition, or in the alternative, the guideline verification module 247 of the PCF framework module 175 may identify and communicate, in real time, one or more alternative selections 196 that may serve as a substantially functional equivalent as the original selection 196 and that fall within applicable guidelines. If all of the selections 196 among the selection options for a landscape 185 (e.g., the initial landscape 685) fall within applicable guidelines, then the process proceeds to step 484. If all of the selections 196 among the selection options for a landscape 185 fall outside one or more applicable guidelines, then the process proceeds to step 489.

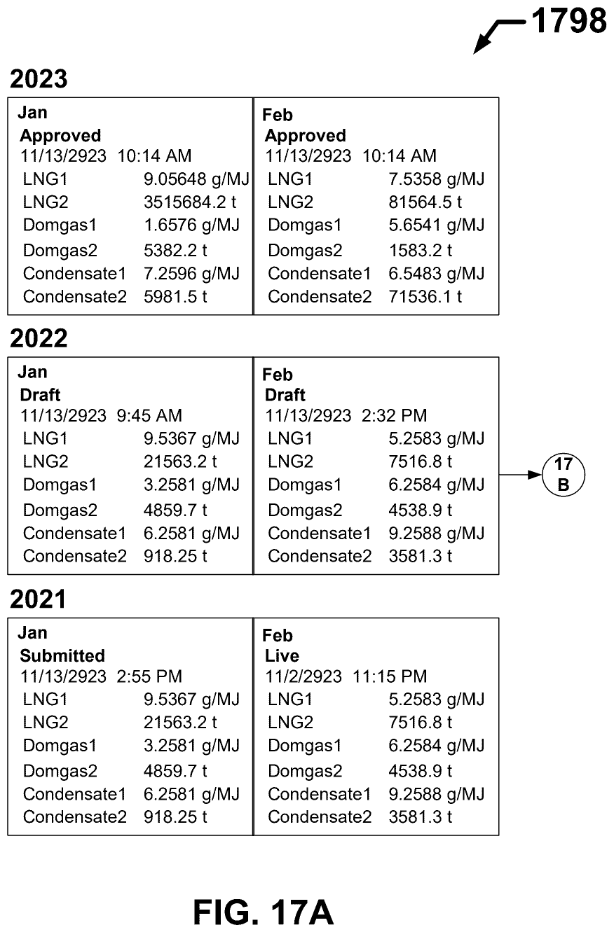

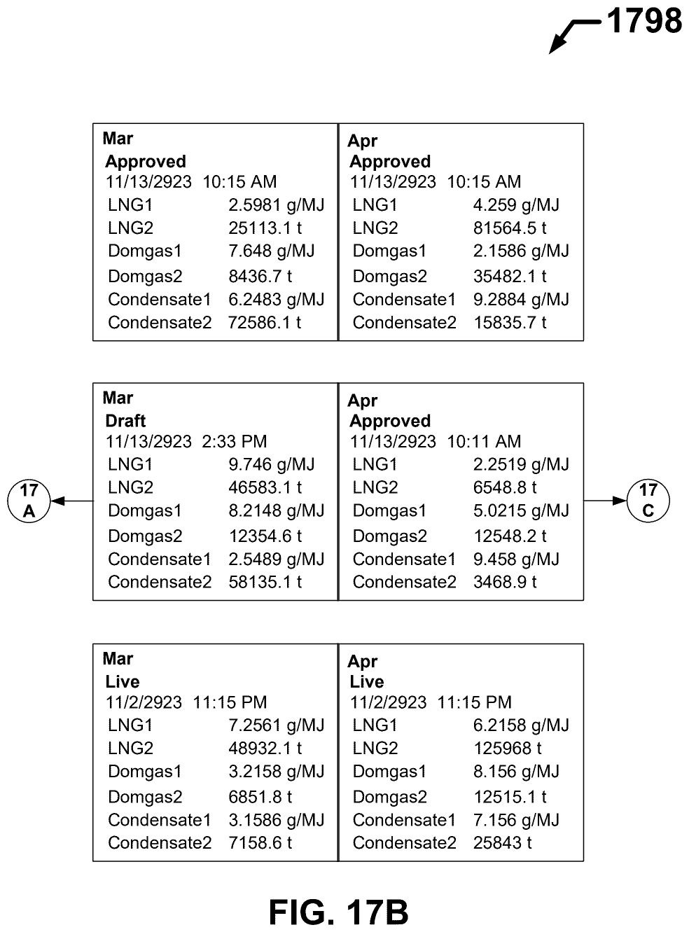

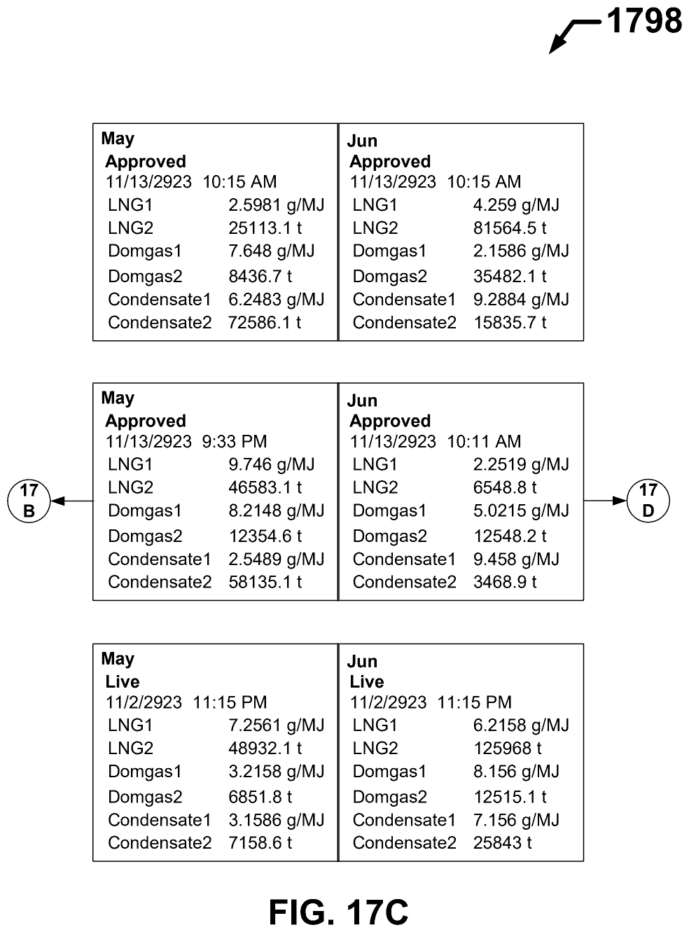

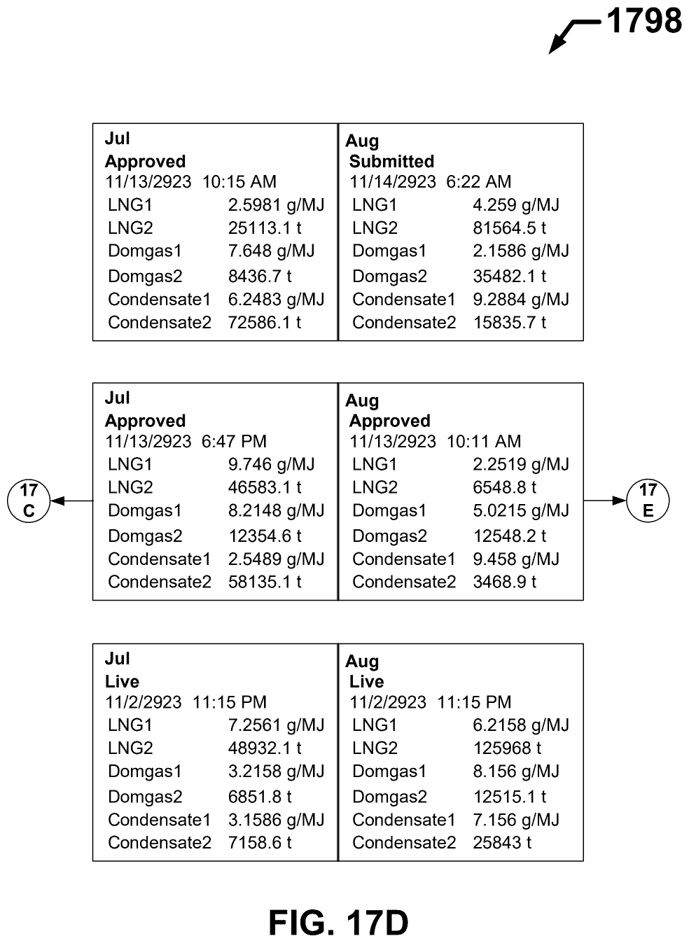

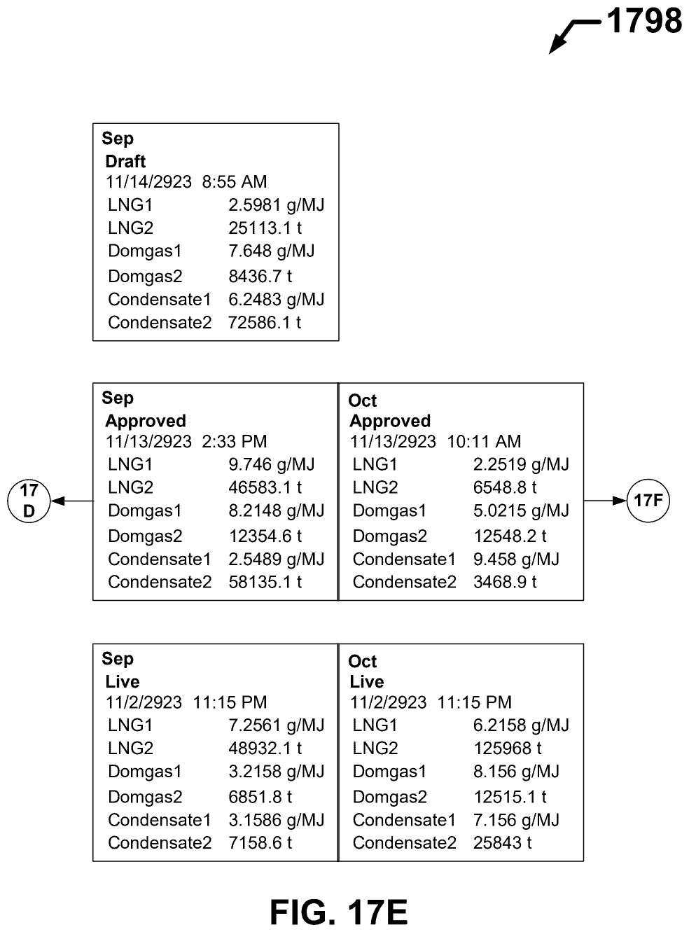

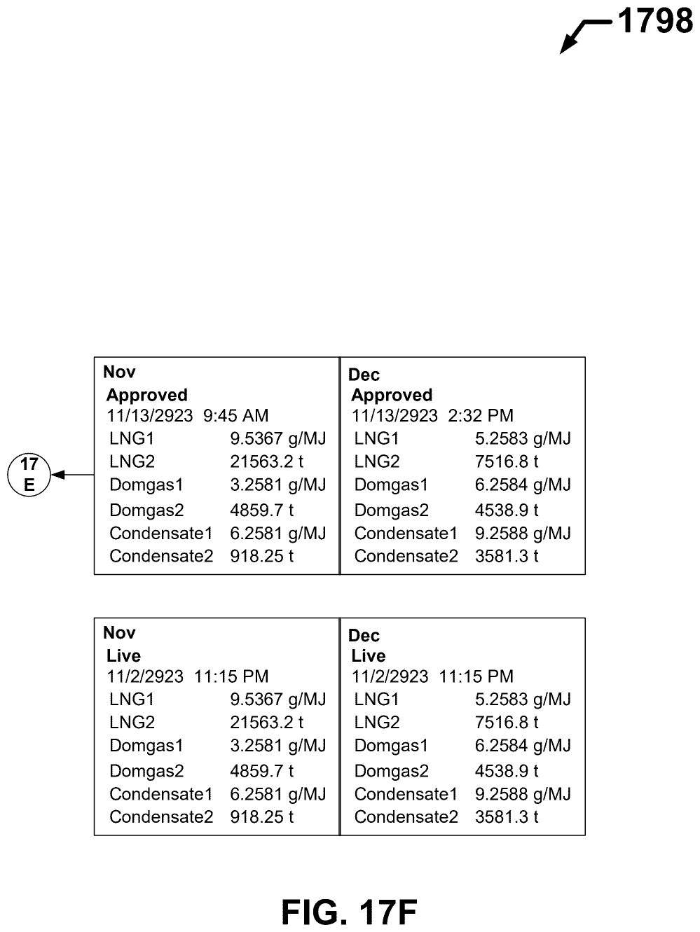

In certain example embodiments, the initial emission-related data 195 must be reviewed and approved by multiple parties before it can be used within a framework to generate a PCF value 186. One or more guidelines that apply to the initial emission-related data 195 is whether all of the necessary reviews and approvals have been made. If not, the control engine 206, using the determinations made by the guideline verification module 247, may identify and communicate with the user, with particular individuals, and/or with particular entities (e.g., departments, groups) in real time to inform them of a review, approval, and/or some other action that is required, and the party responsible for that action, with respect to the initial emission-related data 195 so that such data may be used within the framework to generate a PCF value 186. FIGS. 17A through 17F below show an example of a screenshot 1798 of the status (e.g., live, draft, submitted, approved) of various sets of initial emission-related data 195.

In certain example embodiments, a rejection of workflow (e.g., one or more selections 196 that fall outside applicable guidelines) may allow for revision and resubmission for approval (e.g., express approval by a supervisor, compliance with applicable guidelines) by a user without requiring a restart of the process (e.g., framework) or step (e.g., landscape) in the process. Such revisions (e.g., changes in selections 196, additional selections 196, deleted selections 196) may be suggested, by the controller 204, imposed by the controller 204, and/or initiated by a user. In certain example embodiments, workflow progression may be visible asynchronously, allowing one or more users to see changes in real time, even while those changes are being made. Notes kept by the controller 204 may include an audit trail, even if no comments were entered.

In certain example embodiments, one or more processes (e.g., production, shipping, SGE), may be visible only to authorized users and/or may not be run automatically in the background. In some cases, a process (e.g., part of a framework) may be run on demand by an authorized user (e.g., a process manager) to retrieve the latest live data or after updates to the configuration and/or calculation settings. Example embodiments may allow for transparency to provide additional process run insights (e.g., monitoring of process execution completion status, visibility of results generated from each process execution step).

In step 484, one or more sources of the initial emission-related data 195 is designated. In certain example embodiments, the data source designation module 245 of the PCF framework module 175 of the controller 204 may be configured to designate a source (or multiple sources) of the initial emission-related data 195 (or a processed version thereof) required for the selections 196 among the selection options of the initial landscape 185 using the control engine 206, one or more protocols 232, one or more algorithms 233, and/or stored data 234. Such a designation may be based on the processing of the one or more selections 196 of the initial landscape 185 by the selection processing module 249 and/or the validation of one or more of the selections 196 by the guideline verification module 247.

Such a designation may be done in real time so that immediate feedback may be provided to a user in the event that there are issues or unusual circumstances (e.g., there is no actual initial emission-related data 195 available from a customer 150, a supplier 151, or a sensor device 160, and so the initial emission-related data 195 is to be provided by a third-party source (e.g., via the network manager 180) as an approximation) as a result of one or more of the selections 196 among the selection options made by the user for the initial landscape 185. In addition, or in the alternative, such a designation may prompt the data source designation module 245 to secure the initial emission-related data 195 from the identified sources. In some cases, as when the most recent one or more selections 196 are from an updated landscape 185, there may not be any initial emission-related data 195, in which case this step 484 may be skipped.

In certain example embodiments, any data used in the framework, including the initial emission-related data 195, must first go through some formal approval process. For example, the initial emission-related data 195 must first be reviewed and submitted by one or more entities of a designated group (e.g., one or more suppliers 151, one or more engineers, one or more consultants, part of the controller 204 of the PCF determination apparatus 140), which may change the status of the data from “Live” or “Draft” to “Submitted”. Subsequently, the submitted data may then be reviewed and approved by one or more entities of a different designated group (e.g., one or more customers 151, one or more environmental compliance managers, one or more consultants, another part of the controller 204 of the PCF determination apparatus 140), which may change the status of the data from “Submitted” to “Approved”.

One of the guidelines maintained by the guideline verification module 247 may be that only data that has been submitted and separately approved may be used within a framework or portion (e.g., step) thereof. If needed data for a step in a framework is not yet approved, part of the PCF framework module (e.g., the guideline verification module 247, the landscape maintenance module 253) may inform the user that a problem exists in that data needs to be approved. In some such cases, the controller 204 may suggest in real time alternative (e.g., third part) data that may be available, how the data in question may be approved, and/or the one or more parties responsible for approving the data in question.

In step 487, an updated landscape 185 is presented. The updated landscape 185 may be presented by the landscape maintenance module 253 of the PCF framework module 175 of the controller 204 of the PCF determination apparatus 140. The updated landscape 185 may be presented in real time. The updated landscape 185 may be presented to a user on a user system (e.g., a customer system 155, a supplier system 152). The updated landscape 185 may be presented to the same user as in step 481, the same user as in a prior version or iteration of the landscape 185, and/or some other user. The updated landscape 185 may be the addition of a new landscape and/or the modification (e.g., the expansion) of an existing landscape. The updated landscape may be generated and presented by the PCF framework module 175 based, at least in part, on the selection obtained and processed in step 482 through step 484.

The landscape maintenance module 253 may generate and present the updated landscape 185 using the control engine 206, one or more protocols 232, one or more algorithms 233, stored data 234, the communication module 207, and/or the application interface 226 of the controller 204 of the PCF determination apparatus 140. The updated landscape 185 may be presented in any of a number of different formats using any of a number of different media. When the updated landscape 185 is presented, it may be interactive (e.g., via a user interface) with a user. As discussed above, a user may be a customer 150, a supplier 151, or some other person or entity with an interest in the PCF value 186.

In certain example embodiments, some or all of the updated landscape 185 is validated by the landscape maintenance module 253 of the PCF framework module 175 before it is presented. Validating some or all of the updated landscape 185 may be executed using tables, files, and/or other information in the stored data 234 of the storage repository 231. In addition, or in the alternative, validating some or all of the updated landscape 185 may be executed by interacting with one or more supplier systems 152, one or more customer systems 155, and/or one or more third party systems. Such interactions may include sending queries to obtain information and/or validating information.

In any case, the updated landscape 185 that is presented is unique to and customized for the customer 150 based on factors that may include, but are not limited to, the prior selections 196 obtained, the area of business of the customer 150 and/or the relevant suppliers 151, the geographic scope of the business of the customer 150, the applicable regulations and/or guidelines relative to the business of the customer 150, the facilities within the portfolio of the customer 150 and/or the relevant suppliers 151, and the range of time for which the PCF value is being generated.

In some cases, before proceeding to step 488, a user may elect to make additional changes to the current (e.g., initial) landscape based on the feedback that the user receives in real time from the controller 204 of the PCF determination apparatus 140. For example, part of what the updated landscape that is presented by the landscape maintenance module 253 to a user in real time may include one or more outputs of the step (landscape) based on current selections 196. Based on this information, a user may decide to change, add, and/or remove one or more selections 196 from the current landscape. The landscape maintenance module 253 may then rerun the data through the updated landscape (step) and present the results to the user. This process may repeat itself multiple times before the user accepts the selections 196 that make up the landscape (step) and moves on to step 488.

In step 488, a determination is made as to whether another selection 196 among the selection options from the updated landscape 185 (also sometimes referred to as a subsequent landscape 185 herein) is obtained. As with step 482 above, each selection 196 among the selection options may be obtained from one or more users in the form of one or more customers 150 (via one or more customer systems 155) and/or one or more suppliers 151 (via one or more supplier systems 152). A selection 196 may be obtained by a controller 204 (or portion thereof, such as the landscape maintenance module 253) of the PCF landscape module 175 of the PCF determination apparatus 140 of an emission system 170 using the communication module 207 and/or the application interface 226 of the controller 204 of the PCF determination apparatus 140.

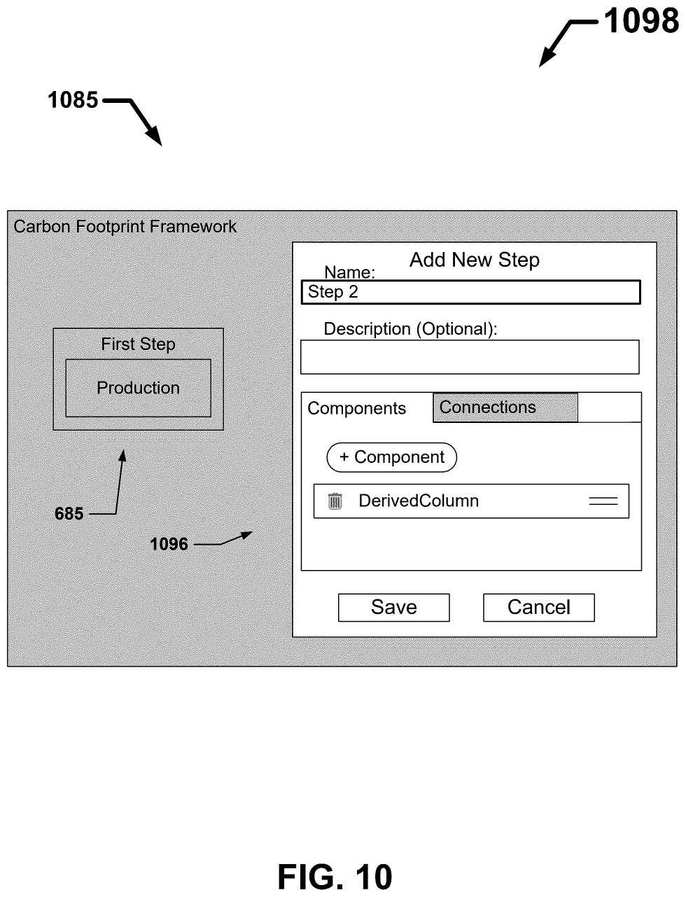

In some cases, multiple selections 196 among the selection options of a subsequent landscape 185 may be an iterative process, taking multiple steps (e.g., multiple iterations of the subsequent landscape 185, multiple back-and-forths within the same iteration) before an overall selection 196 or a series of selections 196 of the subsequent landscape 185 is complete. FIG. 10 shows an example of a screenshot 1098 in which a subsequent or updated landscape 1085 is presented. As with the initial landscape 685, the subsequent or updated landscape 1085 may be the first in a number of iterations. The screenshot 1098 of the updated landscape 1085 of FIG. 10 includes the result of the initial landscape 685 and a dialogue box that includes fields allowing for freeform entry of the name and optional description of the next step. In addition, the dialogue box shown in the screenshot 1098 of FIG. 10 allows for a selection of the selection options “components” or “connections”. In this case, the “components” selection option is the selection 1096 made by the user. Interaction with each of the active fields (selection options) in the updated landscape 1085 represents a selection 1096, which may be considered a separate selection 1096 of the updated landscape 1085 or part of the overall selection 1096 for the initial landscape 1085 (or iteration thereof).

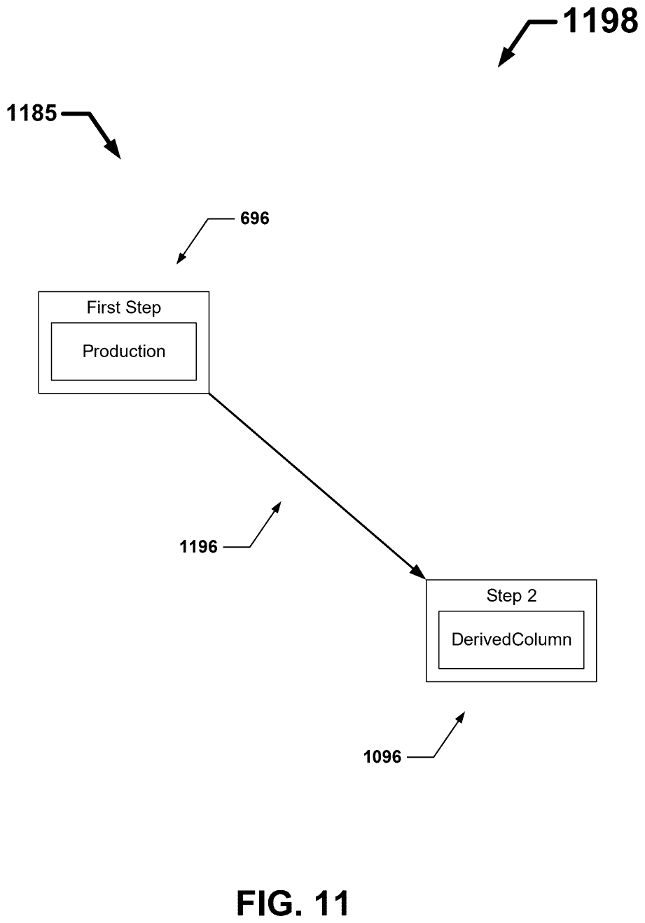

As another example of a selection 1196 made after the initial landscape 685 is finalized is provided in FIG. 11, which shows a screenshot 1198 of a subsequent landscape 1185 that includes the initial landscape 685, the subsequent landscape 1085, and a selection 1196 of a selection option in the form of a link that ties the output of the initial landscape 685 to the input of the subsequent landscape 1085. In such a case, the guideline verification module 247 may analyze (e.g., verify that an applicable guideline is followed) a selection 196 (in this case, selection 1196) of a selection option in the form of a link between two prior selections 196 in the form of processing steps for data (e.g., initial emission-related data 195, partially processed initial emission-related data 195) with the ultimate goal of generating a PCF value 186. For instance, the guideline verification module 247 may verify that the output of one prior selection 196 (e.g., initial emission-related data 195 organized after being received from one or more sources) may be used directly as an input for another prior selection 196 (e.g., formatting the organized initial emission-related data 195) based on a current selection 196 by a user linking the two as part of a process flow.

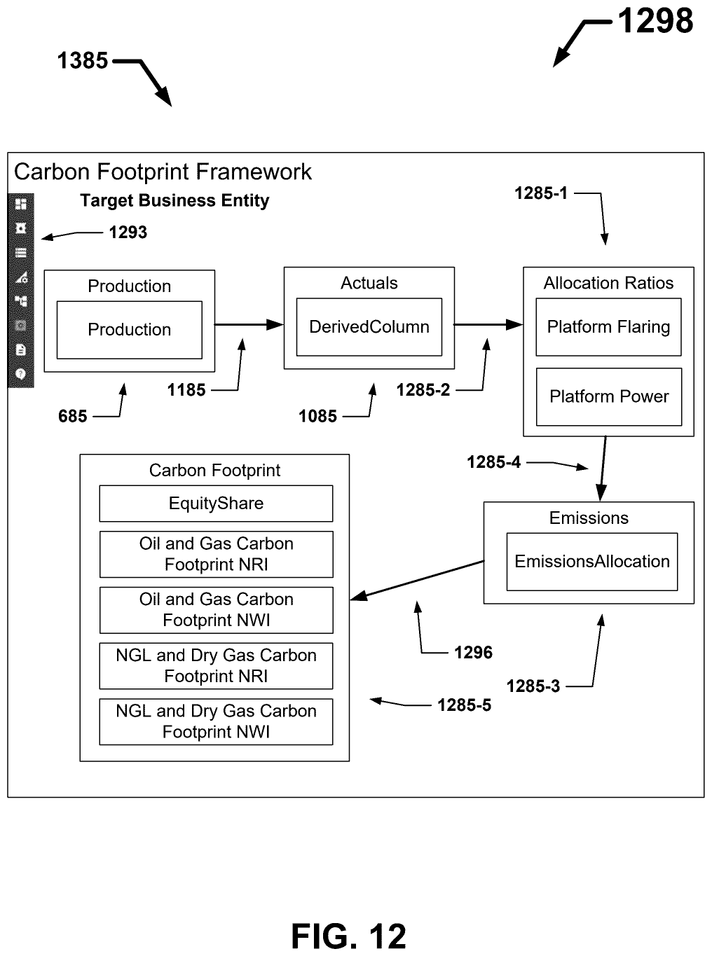

FIG. 12 shows an example of a screenshot 1298 in which a selection 1296 among the selection options is made in a final subsequent landscape 1385 to establish a framework for generating a PCF value. The screenshot 1298 of FIG. 12 includes a list of menu item icons 1293 along the left side, the initial landscape 685, the subsequent landscape 1085 of FIG. 10, the subsequent landscape 1185 of FIG. 11, five other subsequent landscapes 1285, and the selection 1296 of part of the final subsequent landscape 1385 in the form of a link. Subsequent landscape 1285-1 establishes another step in the process in the form of allocation ratios that include platform flaring and platform power. Subsequent landscape 1285-2 establishes a link where the output of the subsequent landscape 1185 is provided as an input for subsequent landscape 1285-1. Subsequent landscape 1285-3 establishes yet another step in the process in the form of emissions that includes emissions allocations.

The list of menu item icons 1293 may include any number of icons leading to different functions. For example, in this case, the first of the menu item icons 1293 may designate a selection for a dashboard. The second of the menu item icons 1293 may designate a selection for a process summary. In certain example embodiments, the process summary icon may consolidate navigation to all processes, allowing easier access for those users who need visibility into multiple processes. The third of the menu item icons 1293 may designate a selection for a data analysis. The fourth of the menu item icons 1293 may designate a selection for calculation settings. The fifth of the menu item icons 1293 may designate a selection for a process manager (e.g., establishing a framework). The sixth of the menu item icons 1293 may designate a selection for a process configuration. The seventh of the menu item icons 1293 may designate a selection for release notes. The eighth and final of the menu item icons 1293 may designate a selection for support.

The list of menu item icons 1293 may be set by default. In addition, or in the alternative, some or all of the list of menu item icons 1293 may be configurable (e.g., by a user, by a customer 150, by the network manager 180). In this case, the screenshot 1298 of FIG. 12 is based on selection of the process configuration icon among the menu item icons 1293.

The list of menu item icons 1293 may help lead to an enhanced user interface experience. For example, landscapes and/or other items (e.g., tables, graphs) presented by the controller 204 of the PCF determination apparatus 140 may use or include expanding arrows, additional and/or alternative icons (e.g., global filter, transportation), drop down menus, and/or other features. As another example, headers may use names in terms of a business context rather than from the context of database field names.

Subsequent landscape 1285-4 establishes a link where the output of the subsequent landscape 1285-1 is provided as an input for subsequent landscape 1285-3. Subsequent landscape 1285-5 establishes a final step in the process in the form of a carbon footprint that includes equity share, oil and gas carbon footprint NRI, oil and gas carbon footprint NWI, NGL and dry gas carbon footprint NRI, and NGL and dry gas carbon footprint NWI. Finally, selection 1296 establishes a link where the output of the subsequent landscape 1285-3 is provided as an input for subsequent landscape 1285-5 which outputs a PCF value 186.

In each of these cases, a subsequent landscape 1285 (including any associated iterations) is generated by the landscape maintenance module 253, and the selections 196 among the selection options of that subsequent landscape 1285 are processed by the selection processing module 249. Similarly, the final subsequent landscape 1385 (including any associated iterations) is generated by the landscape maintenance module 253, and the selections (e.g., selection 1296) among the selection options of the final subsequent landscape 1385 are processed by the selection processing module 249.

While each of the landscapes (e.g., landscape 1285-3, landscape 1085, landscape 1285-5) are linked together in a single series of steps in the example shown in FIG. 12, in alternative embodiments, two or more landscapes may be arranged in parallel with each other, provided that such an arrangement is permitted by the applicable guidelines. For example, the Output from one landscape may be used as an input to two or more landscapes simultaneously. Conversely, in alternative embodiments, the output from multiple landscapes may simultaneously by used as inputs to another single landscape, provided that such an arrangement is permitted by the applicable guidelines.

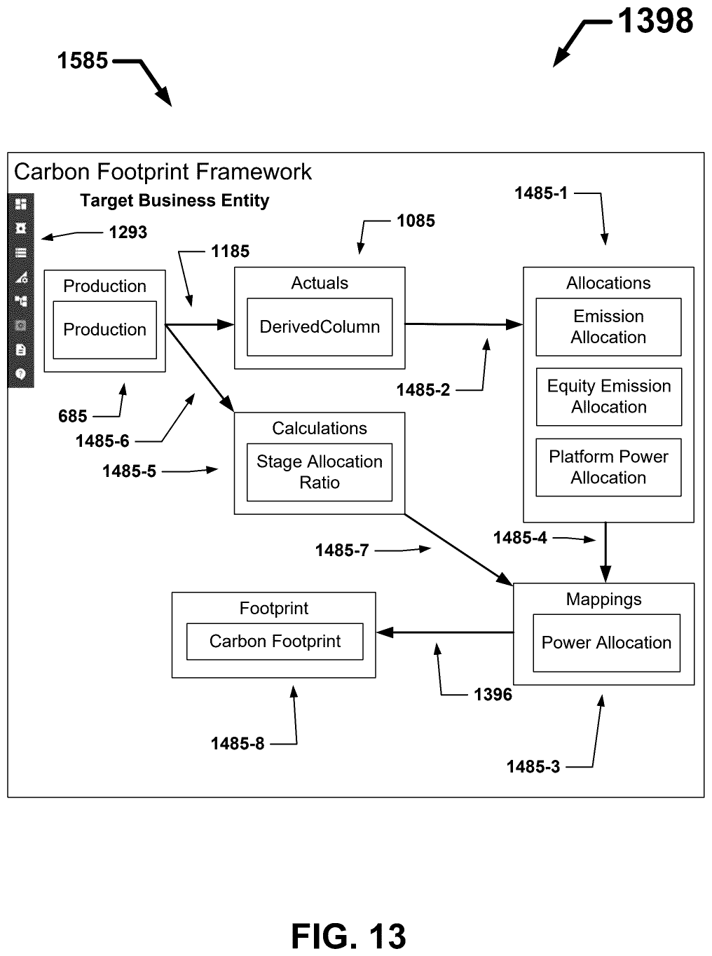

FIG. 13 shows an example of a screenshot 1398 in which a selection 1296 among the selection options is made in a final subsequent landscape 1585 to establish a framework for generating a PCF value. The screenshot 1398 of FIG. 13 includes the list of menu item icons 1293 from FIG. 12 along the left side, the initial landscape 685, the subsequent landscape 1085 of FIG. 10, the subsequent landscape 1185 of FIG. 11, eight other subsequent landscapes 1485, and the selection 1396 of part of the final subsequent landscape 1585 in the form of a link. In this case, the screenshot 1398 of FIG. 13 is based on selection of the process configuration icon among the menu item icons 1293. Subsequent landscape 1485-1 establishes another step in the process in the form of allocations that include emission allocation, equity emission allocation, and platform power allocation. Subsequent landscape 1485-2 establishes a link where the output of the subsequent landscape 1185 is provided as an input for subsequent landscape 1485-1.

Subsequent landscape 1485-3 establishes yet another step in the process in the form of mappings that includes power allocation. Subsequent landscape 1485-4 establishes a link where the output of the subsequent landscape 1485-1 is provided as an input for subsequent landscape 1485-3. Subsequent landscape 1485-5 establishes yet another step in the process in the form of calculations that includes stage allocation ratio. Subsequent landscape 1485-6 establishes a link where the output of the initial landscape 685 is provided as an input for subsequent landscape 1485-6. Subsequent landscape 1485-7 establishes a link where the output of the subsequent landscape 1485-5 is provided as an input for subsequent landscape 1485-3. Subsequent landscape 1485-8 establishes yet another step in the process in the form of footprint that includes carbon footprint. Finally, selection 1396 establishes a link where the output of the subsequent landscape 1485-3 is provided as an input for subsequent landscape 1485-8 which outputs a PCF value 186.

In any case, when a selection 196 (or the part of the selection 196) is received, the selection processing module 249 of the PCF framework module 175 of the controller 204 may be configured to perform one or more of a number of checks or validations (e.g., using one or more guidelines, using one or more protocols 232) with respect to the selection 196. In this way, in real time, the selection processing module 249 of the PCF framework module 175 may determine whether the selection 196 is valid and may be used. The selection processing module 249 may also be configured to determine whether the user making the selection 196 is authorized to do so and/or how to resolve issues (e.g., using a hierarchy) that arise when the selection 196 conflicts with a prior selection 196 in the landscape 185. Example embodiments may allow for users with assigned permissions to view, create, delete, copy, and/or modify existing process configurations (frameworks).

In response, the landscape maintenance module 253 may generate another iteration with selection options (e.g., a new dialogue box) of the subsequent landscape 685 to solicit one or more further selections 196. In other words, the selection options presented in the subsequent landscape 685 may be generated by the controller 204 in real time based on one or more of a number of factors, including but not limited to the selections 196 received to that point, the number of users involved, the availability of required data based on the selection 196, and the level of authority of the user (or each user). This process may repeat itself until the landscape maintenance module 253 determines that no further selections 196 are needed to complete the subsequent landscape 185, assuming that all of the selections 196 are valid. If one or more selections 196 from the updated landscape 185 (also sometimes referred to as a subsequent landscape 185 herein) are obtained, then the process reverts to step 483. If one or more selections 196 from the updated landscape 185 (also sometimes referred to as a subsequent landscape 185 herein) are not obtained, then the process proceeds to step 461.

In step 489, a notification that one or more of the selections 196 for a landscape 185 are not acceptable is sent. Such a notification may take one or more of a number of forms. Examples of such forms of the notification may include, but are not limited to, an email, a text message, an audio output, an alarm, a message on a display, an alert on an app, and a light indication. Such a notification may be sent to the user making the selection at issue. In addition, or in the alternative, such a notification may be sent to a third party (e.g., a supervisor, an authorized representative). More generally, if there is a failure, the controller 204 shows the user what the failure is in real time. In such cases, the user may then take corrective action to overcome the failure in real time. In certain example embodiments, the controller 204 presents, in real time, one or more options to a user that, once selected by the user, allows the failure to be overcome.

Such a notification may be generated and sent by the landscape maintenance module 253 of the PCF framework module 175 of the controller 204 of the PCF determination apparatus 140. In such a case, if a selection 196 does not fall within one or more guidelines, as determined by the guideline verification module 247, the guideline verification module 247 may communicate the details to the landscape maintenance module 253, which in turn may generate and send the notification to communicate the issue (e.g., in general terms, in specific terms) that the selection 196 cannot be accepted (either in full or in part). The landscape maintenance module 253 may use, for example, the control engine 206, the communication module 207, one or more protocols 232, one or more protocols 232, and/or stored data 234 to generate and/or send the notification. In some cases, a notification may include one or more alternatives and/or solutions that the user may take to overcome the issue with a selection 196 that is not acceptable. Alternatively, a notification may state an action taken, automatically and independent of user input (e.g., based on one or more protocols 232), by the landscape maintenance module 253 and/or other part of the controller 204 to overcome the problem with the selection 196.

In step 461, the initial emission-related data 195 is obtained. The initial emission-related data 195 may be obtained by the landscape maintenance module 253 of the PCF framework module 175 of the controller 204 of the PCF determination apparatus 140. Alternatively, the initial emission-related data 195 may be obtained by the data source designation module 245 of the PCF framework module 175 of the controller 204 of the PCF determination apparatus 140. In yet other alternative embodiments, the initial emission-related data 195 may be obtained by the control engine 206 of the controller 204. In any case, the initial emission-related data 195 may be obtained from the one or more sources designated by the data source designation module 245 of the PCF framework module 175 of the controller 204 of the PCF determination apparatus 140 as described in step 484. The initial emission-related data 195 may be obtained using the control engine 206, the communication module 207, one or more protocols 232, one or more protocols 232, and/or stored data 234.

In some cases, all of the initial emission-related data 195 is primary data, which means that the initial emission-related data 195 comes directly from the customer 150 and/or an associated supplier 151. In other cases, a portion of the initial emission-related data 195 also includes some amount of secondary data, which is data that comes from some other source (e.g., a governing entity, an industry group, a standard). Secondary data may be used when primary data is needed to determine a PCF value but is unavailable for some reason (e.g., faulty sensor device, lack of infrastructure to measure a parameter, failed communication, loss of original data). When secondary data is used as part of the initial emission-related data 195, the amount and/or source of the secondary data may be controlled by a user (e.g., based on experience) and/or the controller 204 of the PCF determination apparatus 140 using one or more protocols 232 and/or one or more algorithms 233. In some cases, secondary data is only used in determining a PCF value herein when primary data is unavailable, as determined in real time by the PCF determination apparatus 140 (or portions thereof, such as the data source designation module 245), for a particular time period and/or for some other particular factor (e.g., production, transportation, storage).

In some cases, the initial emission-related data 195 may be obtained for a particular time period that has already been through some or all of the process captured in the flowchart 458 of FIG. 4. For example, if initial emission-related data 195 related to production of a product in January of the current year has already been obtained, and then subsequently additional initial emission-related data 195 for production of the product in January of the current year is obtained, a processing may be initiated for only the subsequently received additional initial emission-related data 195. Alternatively, all of the initial emission-related data 195, including the previously obtained data, may be processed collectively.

In step 462, the initial emission-related data 195 is processed following the framework that has been established. The initial emission-related data 195 may be processed by the data processing module 243 of the controller 204 of the PCF determination apparatus 140. In such a case, the data processing module 243 may process the initial emission-related data 195 following the framework using the control engine 206, the communication module 207, one or more protocols 232, one or more protocols 232, and/or stored data 234. In certain example embodiments, when the last step of the framework is executed, a PCF value 186 is generated.

Example embodiments may allow for tracking changes to frameworks (e.g., changes to a step, changes to settings, changes to a guideline), in some cases by user. Example embodiments may allow for tracking user and/or version information for runs of frameworks. Example embodiments may allow for replicating a run of a framework. Example embodiments may allow for displaying run duration for process (frameworks), steps, and/or components. Example embodiments may allow for supporting efficient scaling across multiple methodologies, business enterprises, and/or calculations.

In step 463, the PCF value 186 is communicated. The PCF value 186 may be communicated by the data processing module 243, the control engine 206, or some other component of the controller 204 of the PCF determination apparatus 140. The PCF value 186 may be communicated to the one or more users that established the framework, a customer 150, a supplier 151, a third party (e.g., a compliance agency, an auditor), and/or some other entity. The PCF value 186 186 may be communicated in one or more of any of a number of ways. Examples of such ways that the PCF value may be communicated may include, but are not limited to, an email, a text message, an audio output, an alarm, a message on a display, and an alert on an app. The PCF value 186 may be communicated using the control engine 206, the communication module 207, one or more protocols 232, one or more protocols 232, and/or stored data 234.

In certain example embodiments, the PCF value 186 may be communicated as part of a Statement of Greenhouse Gas Emissions (SGE) report. In some cases, SGE reports may be producible on demand for any chosen framework. In some cases, SGE reports will only be generated upon approval by certain people or entities. Such approval may be sought when certain specific preconditions (e.g., both approved production and shipping data appear in correct time frames) are met. In some cases, a prior approval may be needed before the preconditions are checked. When step 463, the process may proceed to the END step.

Example embodiments may also be configured to allow a user to access (e.g., subject to and/or based on sufficient authority) other frameworks, past data used for generating PCF values 186, audit history, and/or other information related to example frameworks and generating PCF values 186. In addition, or in the alternative, a user may access graphical representations of PCF values 186 and/or related information for implementations of current frameworks and/or past frameworks using example embodiments.

In some cases, a user may view a history of runs using example embodiments, where each run is a calculation of a PCF value 186 using a particular framework. In such cases, a user may retrieve such information as the generated PCF values 186, the various steps in the framework, how the steps are linked, the user or users show created/edited the framework, how many versions of the framework exist, which version was used to generate which particular PCF values 186, notes that may have been made as to why a version of the framework was changed, etc. For example, the controller 204 may obtain a request to review a prior generation of emission-related data (e.g., approval workflow of the emission-related data, the emission-related data itself, an individual responsible for the prior generation of the emission-related data, a date and time when the prior generation of the emission-related data was created, sources providing the initial emission-related data used to produce the prior generation of the emission-related data, version history of the framework or portions thereof, individual users who selected specific steps within a framework, a specific user that approved the framework and/or the data, a specific user that executed a run using a framework to generate a PCF value 186), and the controller 204 may respond by presenting the prior generation of the emission-related data to a user.

The PCF determination apparatus 140, including portions thereof, may be configured to provide improved architecture for storing and processing data used to generate a PCF value 186. In addition, or in the alternative, the determination apparatus 140, including portions thereof, may be configured to provide improved performance, calculation processing, and scalability. In addition, or in the alternative, the determination apparatus 140, including portions thereof, may be configured to provide improved mass, energy, and volume UOM conversion performance and data accuracy.

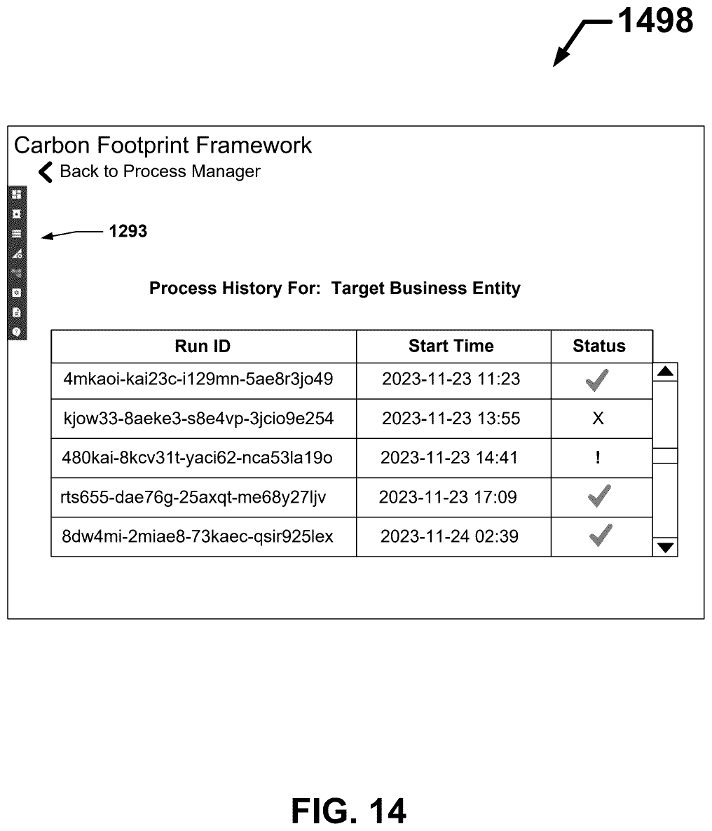

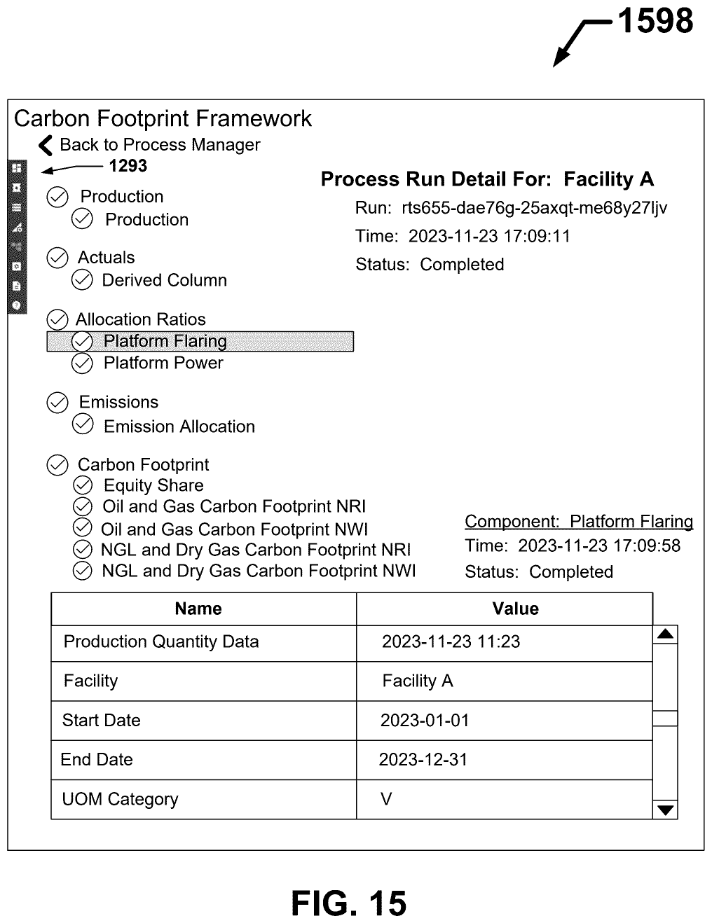

FIGS. 14 through 20 show examples of screenshots (or portions thereof) that may be presented in accessing previously-developed frameworks and related data according to certain example embodiments. For example, FIG. 14 shows a screenshot 1498 where a user has accessed a table of previous runs, by selecting the process manager icon from among the menu item icons 1293, to determine a PCF value 186 using a particular framework. The columns in the table include an identification of the run, a start date/time of the run, and the status of the run. FIG. 15 shows a screenshot 1598 of a particular run that was selected from the table shown in the screenshot 1498 of FIG. 14. The screenshot 1598 of FIG. 15 gives the run identification, the start date/time of the run, and the status of the run that was selected. In this case, the screenshot 1598 of FIG. 15 is based on selection of the process manager icon among the menu item icons 1293.

In addition, the screenshot 1598 includes a menu of categories (selection options) within the framework that are selectable by a user. In this case, the user has selected the “Power Platform” subcategory (a selection option) within the “Allocation Ratios” category (a selection option). These categories and subcategories correspond to the landscapes shown in the screenshot 1298 of FIG. 12 above. For this selection, a user may view inputs, outputs, and results. In this case, the inputs are shown in the screenshot 1598 in table form where the names and values of the inputs are listed.

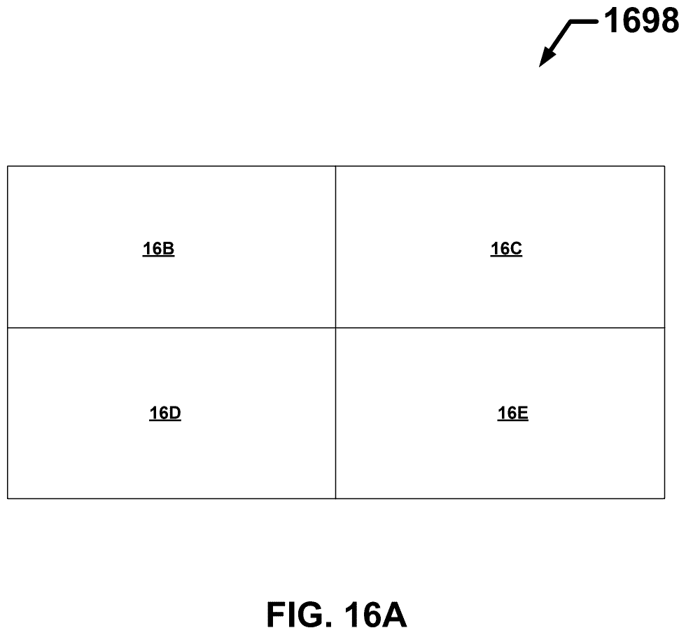

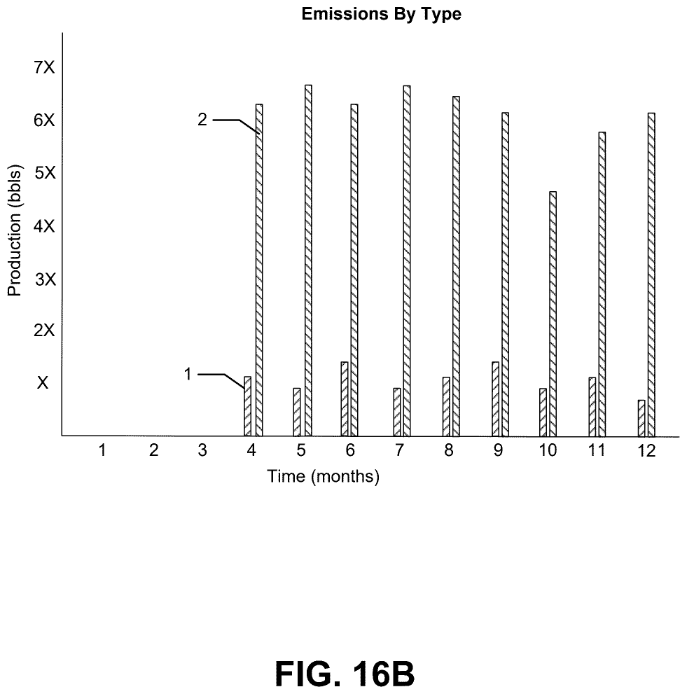

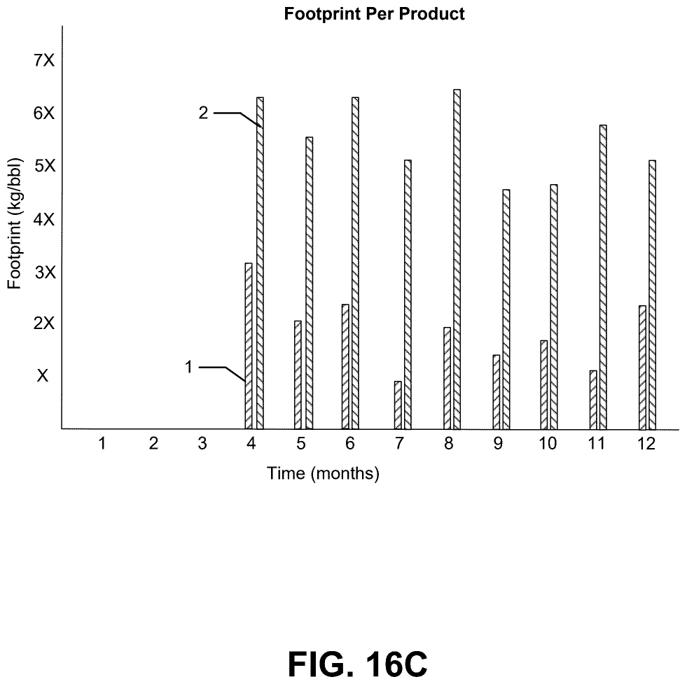

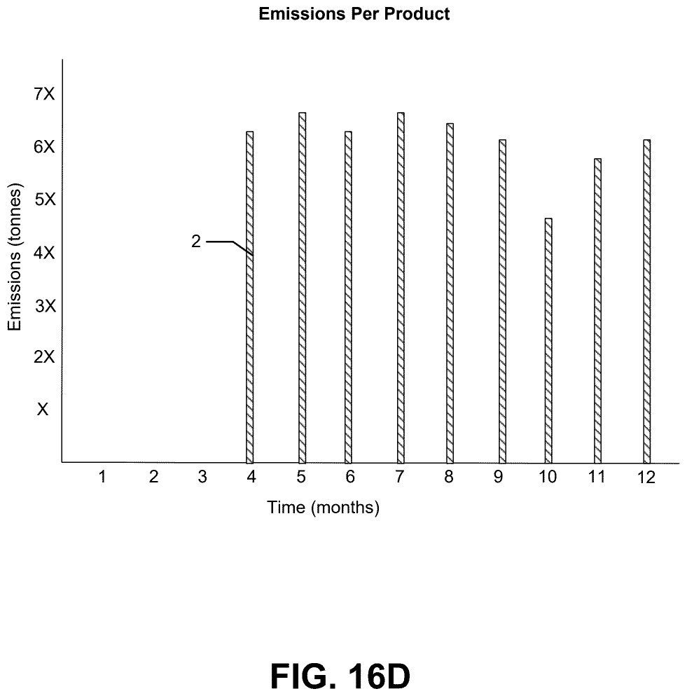

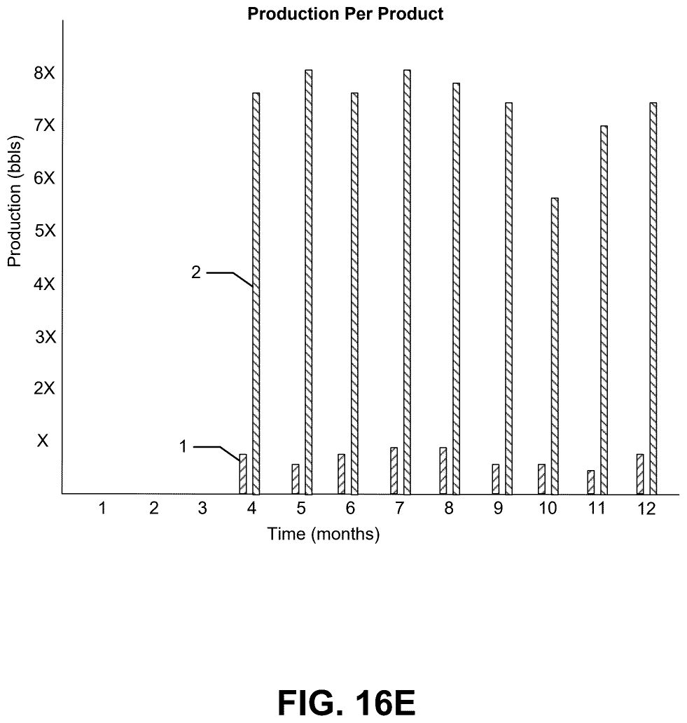

FIGS. 16A through 16E show a screenshot 1698, divided into four sections in the form of graphs, where each graph includes data from a single framework or multiple frameworks in multiple graphical forms. Specifically, FIG. 16A shows an overview of the screenshot 1698, and FIGS. 16B through 16E show the four graphs that fit within the screenshot 1698 of FIG. 16A. In other words, the screenshot 1698 presents a dashboard in the form of four graphs. The data shown in each graph, the format of each graph, and/or other factors regarding the data may be controlled by a user. In this case, the screenshot 1698 of FIG. 16A and the graphs detailed in FIGS. 16B through 16E are based on one or more selections of the dashboard icon among the menu item icons 1293. FIGS. 17A through 17F show a details of screenshot 1798 of a process summary of initial emission-related data 195 obtained from one or more sources. In this case, the screenshot 1798 of FIGS. 17A through 17F is based on one or more selections of the process summary icon among the menu item icons 1293.

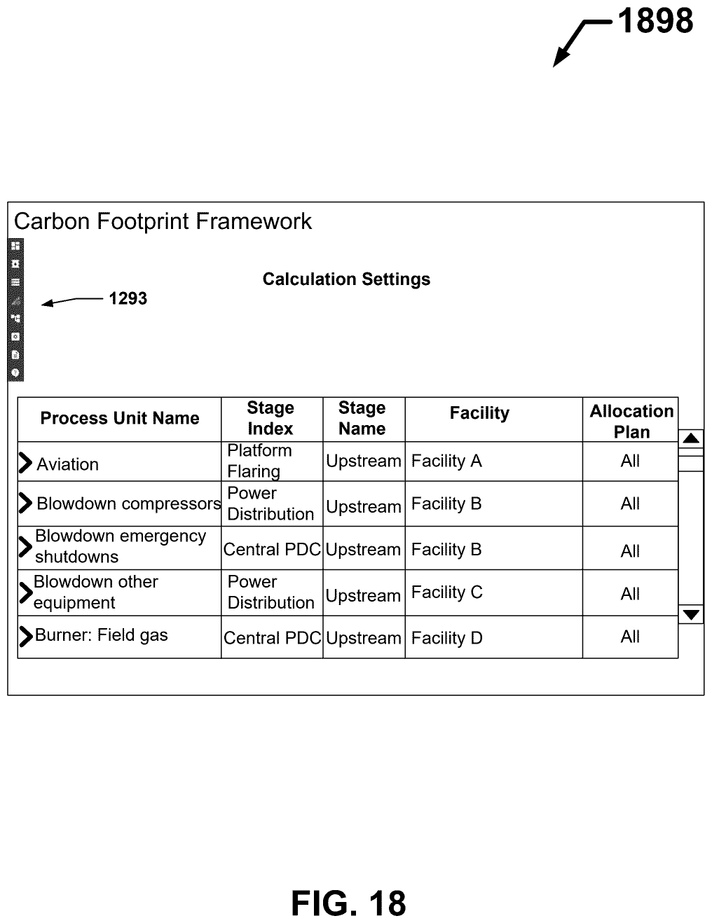

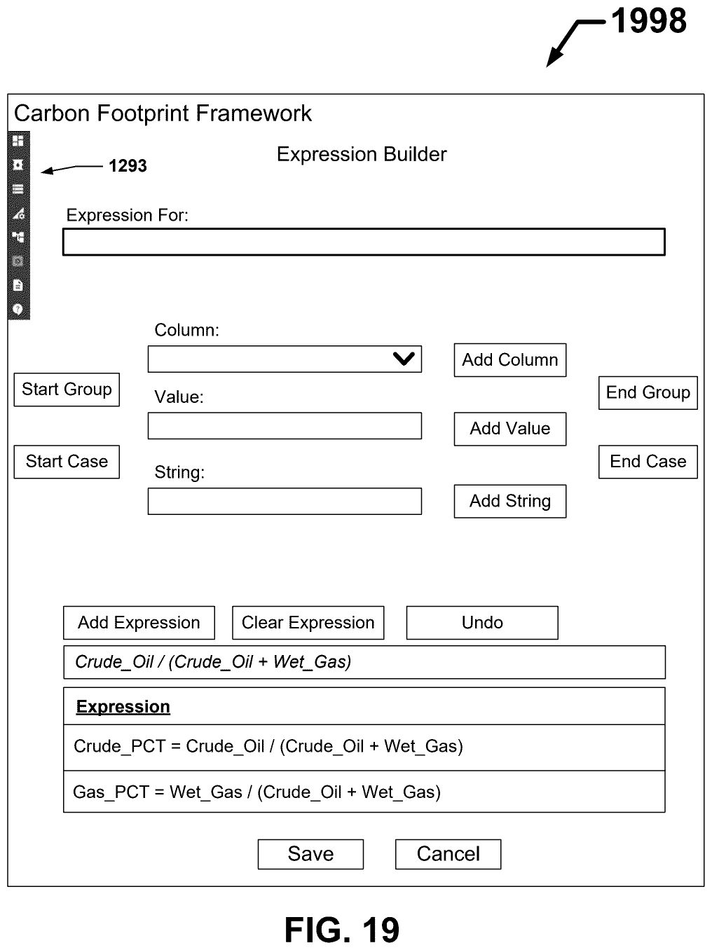

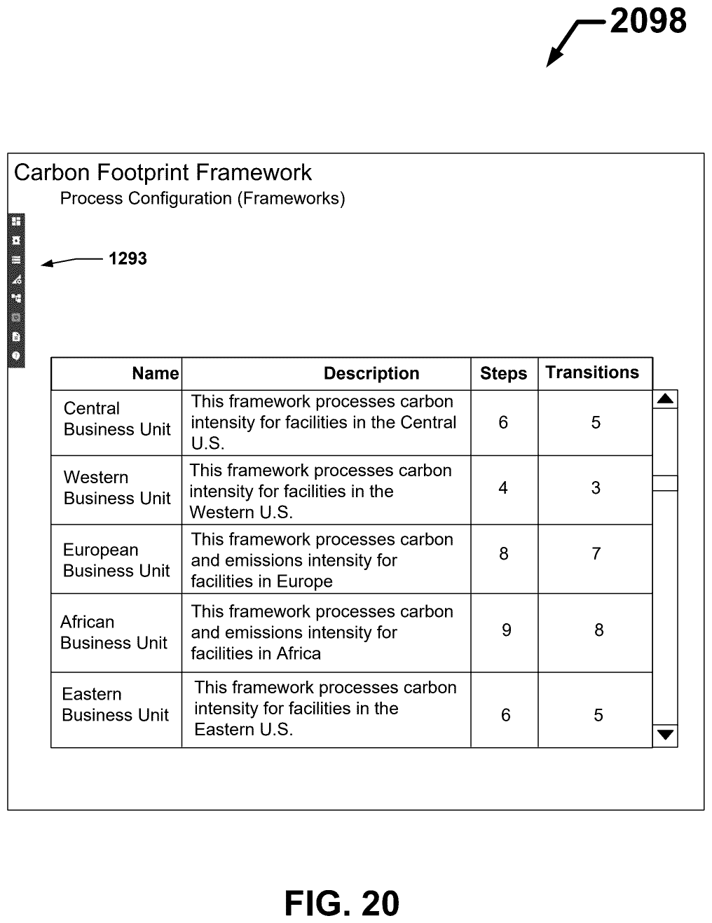

FIG. 18 shows a screenshot 1898 of a table that shows various settings associated with a framework. Each line item in the table shown in the screenshot 1898 may be fully editable by a user, partially editable by a user, or read only. In this case, the screenshot 1898 of FIG. 18 is based on selection of the calculation settings icon among the menu item icons 1293. FIG. 19 shows a screenshot 1998 of an entry table that allows a user to add and/or modify an expression (e.g., formulas, models, and/or other algorithms 233) and associated details. In this case, the screenshot 1998 of FIG. 19 is based on selection of the process configuration icon among the menu item icons 1293. FIG. 20 shows a screenshot 2098 that includes a process configuration table that lists the name, description, number of steps (landscapes), and number of transitions (links) of each framework that has been developed. In this case, the table in the screenshot 1998 is read only. In this case, the screenshot 2098 of FIG. 20 is based on selection of the process configuration icon among the menu item icons 1293.

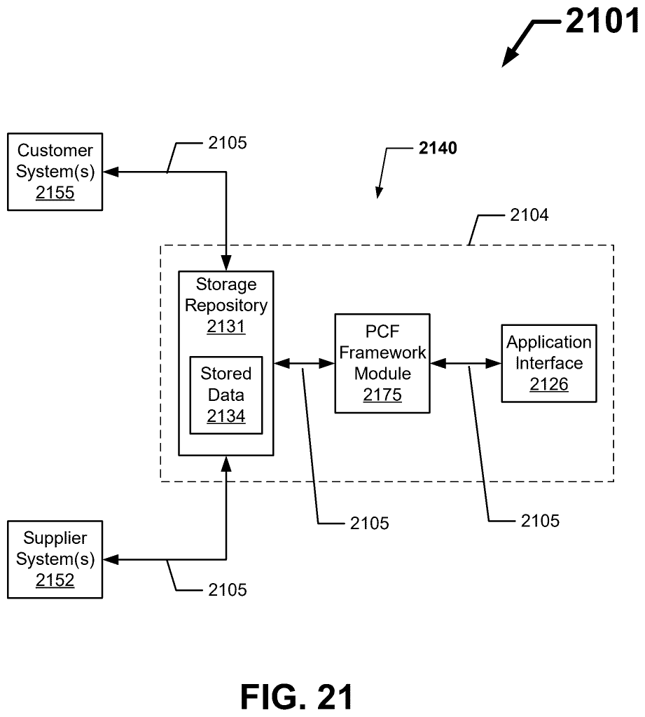

FIG. 21 shows a general system architecture diagram 2101 for a system for determining PCF values using a configuration driven PCF framework module according to certain example embodiments. Referring to the description above with respect to FIGS. 1 through 20, the system architecture diagram 2101 of FIG. 21 includes one or more customer systems 2155, one or more supplier systems 2152, a storage repository 2131 (including stored data 2134), a PCF framework module 2175, and an application interface 2126. The storage repository 2131 (including the stored data 2134), the PCF framework module 2175, and the application interface 2126 are part of a controller 2104 of a PCF determination apparatus 2170. Each component of the system architecture diagram 2101 communicates with another component of the system architecture diagram 2101 using communication links 2105.

The customer systems 2155, the supplier systems 2152, the storage repository 2131 (including the stored data 2134), the PCF framework module 2175, the application interface 2126, the controller 2104, the PCF determination apparatus 2140, and the communication links 2105 are substantially the same as the customer systems 155, the supplier systems 152, the storage repository 231 (including the stored data 234), the PCF framework module 175, the application interface 226, the controller 204, the PCF determination apparatus 140, and the communication links 105 discussed above.

For example, the application interface 2126 may be or include software loaded on the system of a user (e.g., a customer system 2155) and/or a web browser. The application interface 2126 may serve as an interaction point with the end user (e.g., a customer 150, a customer system 155). In addition, or in the alternative, the application interface 2126 may allow for the creation, modification, and/or deletion of process configurations. In addition, or in the alternative, the application interface 2126 may allow for triggering process execution and displaying execution status and results. In addition, or in the alternative, the application interface 2126 may include a security layer (e.g., using the security module 223) so that only authorized users with permission can access certain interactions.

As another example, the PCF framework module 2175 may include a number of modules or services. An example of one such module or service is a configuration service that manages process configuration (e.g., generating and presenting a landscape 185, generating a PCF value 186). In addition, or in the alternative, the configuration service may provide functionality for creation, modification, and/or deletion of process constructs (e.g., process, steps, components). In addition, or in the alternative, the configuration service may interact with the underlying configuration storage mechanism (e.g., stored data 2134 in the storage repository 231). In addition, or in the alternative, the configuration service may manage storage and retrieval of data (e.g., stored data 2134 in the storage repository 231, data that resides on a computer of a third party (e.g., a customer system 155, a supplier system 152, a regulatory agency) needed for lookups (e.g., get products for a given facility). Some or all of the functions performed as part of the configuration service of the PCF framework module 2175 may be performed by the guideline verification module 247, the selection processing module 249, the data source designation module 245, and/or the landscape maintenance module 253.

Another example of a module or service of the PCF framework module 2175 is an orchestration service that manages the orchestration of the execution of a process. In addition, or in the alternative, the orchestration service may create an execution plan based on the process configuration, where the execution plan details the sequence of execution and passing data between sequential steps. In addition, or in the alternative, the orchestration service may communicate with external execution engines, including managing long running processes in the background. In addition, or in the alternative, the orchestration service may provide information about real-time execution status and progress. In addition, or in the alternative, the orchestration service may mange the storage and retrieval of data with the storage repository 231. Some or all of the functions performed as part of the orchestration service of the PCF framework module 2175 may be performed by the guideline verification module 247, the selection processing module 249, the data source designation module 245, and/or the landscape maintenance module 253.

Yet another example of a module or service of the PCF framework module 2175 is an event service that relays events from the orchestration service, the configuration service, and/or other services to the application interface 2126 (e.g., a user interface) for real-time status updates. Some or all of the functions performed as part of the event service of the PCF framework module 2175 may be performed by the guideline verification module 247, the selection processing module 249, the data source designation module 245, and/or the landscape maintenance module 253.

Still another example of a module or service of the PCF framework module 2175 is an execution service that is responsible for interpreting and executing a given configuration file from the orchestration service. In addition, or in the alternative, the execution service may process the various inputs using one or more protocols 232 and/or one or more algorithms 233. In addition, or in the alternative, the execution service may store the output of those operations in the storage repository 231 (e.g., in a results database under the stored data 2134). In addition, or in the alternative, the execution service may send updates to the orchestration service regarding progress of the execution. Some or all of the functions performed as part of the execution service of the PCF framework module 2175 may be performed by the guideline verification module 247, the selection processing module 249, the data source designation module 245, and/or the landscape maintenance module 253.

The stored data 2134 of the storage repository 2131 of the PCF framework module 2175 may have multiple components or databases. For example, the stored data 2134 of the storage repository 2131 of the PCF framework module 2175 may include a configuration database that is configured to store semi-structured data files in a particular format (e.g., JSON). In addition, or in the alternative, the configuration database may be designed to support the configuration service of the PCF framework module 2175 and/or the application interface 2126. In some cases, the configuration data stored in configuration database of the stored data 2134 may include, for example, reference data, metadata, component definition data, and security information. In some cases, the configuration database of the stored data 2134 may store configuration information for applications and systems, which allows the PCF framework module 2175 to manage and/or update configuration settings, making it easier to maintain and scale applications (e.g., within a customer system 155 with a large number of users and/or businesses, within an industry with a large number of customers 151) over time.

As another example, the stored data 2134 of the storage repository 2131 of the PCF framework module 2175 may include a results database, which may be an area of the stored data 2134 where data (e.g., emission-related data 195, selections 196, inputs, intermediate data, landscapes 185, PCF values 186, outputs) are staged and used by the execution service of the PCF framework module 2175 (discussed above) to perform calculations. In some cases, data in the results database may be organized in different folders depending on whether the data set is an input, is created as an intermediate data set (e.g., from performing a set of calculations), or is a final data output.

Example embodiments can be used to generate a framework in real time, where the framework can be used to help determine a PCF value for a customer. Example embodiments receive a number of selections of various selection options from a user, and these selections form the basis of one or more landscapes, which in aggregate form the framework. Example embodiments are designed to process emissions-related data across industries. Using example embodiments, a framework can be generated and/or updated in real time to account for changes in available data, user preferences and/or selections, regulations, standards, and/or other sources that can influence changes in how the PCF value is determined using the emissions-related data. Example embodiments eliminate or greatly reduce the need for human involvement in developing a framework with flexibility and customization to determine the PCF value. Example embodiments also provide a number of other benefits. Such other benefits can include, but are not limited to, less use of resources, greater operational flexibility, time savings, standardized processes, reliable PCF values, and compliance with applicable industry standards and regulations.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A computer-implemented method for establishing a product carbon footprint (PCF) framework for a corporate entity, the computer-implemented method comprising:
presenting a first landscape comprising a first plurality of selection options to determine how to generate a PCF value for the corporate entity;
obtaining a first selection of a first selection option among the first plurality of selection options from a user of a customer, wherein the first selection comprises first instructions for processing initial emission-related data to generate first emission-related data, and wherein the initial emission-related data is associated with a business segment of the corporate entity;
verifying, in real time, that the first selection falls within a first set of current guidelines;
designating, in real time, a source of the initial emission-related data;
presenting, based on the first selection, a second landscape comprising a second plurality of selection options to further determine how to generate the PCF value for the corporate entity;
obtaining a second selection of a second selection option among the second plurality of selection options from the user of the customer, wherein the second selection comprises second instructions for processing the first emission-related data to generate second emission-related data, and wherein the second emission-related data is used to generate the PCF value;
verifying, in real time, that the second selection falls within a second set of current guidelines;
presenting, based on the first selection and the second selection, a third landscape comprising a third plurality of selection options to further determine how to generate the PCF value for the corporate entity;
obtaining a third selection of a third selection option among the third plurality of selection options from the user of the customer, wherein the third selection instructs the first emission-related data generated by the first selection to be an input for the second selection; and
verifying, in real time, that the third selection falls within a third set of current guidelines that apply to tying the first selection to the second selection.

2. The computer-implemented method of claim 1, further comprising:
obtaining a change to a business process of the corporate entity;
determining that the change affects the first set of current guidelines; and
updating the first set of current guidelines based on the change.

3. The computer-implemented method of claim 2, further comprising verifying that the first selection continues to fall within the first set of current guidelines after the first set of current guidelines is updated.

4. The computer-implemented method of claim 1, further comprising:
obtaining a request to review a prior generation of the first emission-related data; and
presenting the prior generation of the first emission-related data.

5. The computer-implemented method of claim 4, wherein the prior generation of the first emission-related data comprises at least one of a group consisting of an individual responsible for the prior generation of the first emission-related data, a date and time when the prior generation of the first emission-related data was created, and sources providing the initial emission-related data used to produce the prior generation of the first emission-related data.

6. The computer-implemented method of claim 1, further comprising:
determining that the initial emission-related data is incomplete to generate the first emission-related data using the first selection;
identifying secondary data from a secondary source to complement the initial emission-related data; and
combining the secondary data with the initial emission-related data to generate the first emission-related data.

7. The computer-implemented method of claim 1, wherein the first instructions are based on at least one of a group consisting of a power allocation among equipment used by the business segment, an allocation of the equipment used by the business segment, an equity share of the business segment, an emission factor that applies to the business segment, transportation used for the business segment, and a global warming potential of a greenhouse gas.

8. The computer-implemented method of claim 1, further comprising processing the initial emission-related data according to a schedule.

9. The computer-implemented method of claim 1, wherein the first selection further comprises at least one of a group consisting of production parameters, mapping parameters, data step parameters, calculations, allocations, and footprint parameters.

10. The computer-implemented method of claim 1, wherein the first selection further comprises a range of dates during which the initial emission-related data is generated.

11. The computer-implemented method of claim 1, further comprising:
determining that the first selection falls outside the first set of current guidelines; and
recommending a change to the first selection that allows the first selection to fall within the first set of current guidelines.

12. The computer-implemented method of claim 1, further comprising limiting, based on a level of authority associated with the user, a scope of the first instructions that are obtained from the first selection.

13. The computer-implemented method of claim 1, further comprising:
receiving a fourth selection from the user of the customer, wherein the fourth selection comprises a request for summary information for a selection of the second emission-related data; and
presenting the summary information.

14. The computer-implemented method of claim 1, further comprising:
obtaining the initial emission-related data from a data source; and
executing the first instructions to process the initial emission-related data.

15. The computer-implemented method of claim 1, further comprising generating the PCF value based on the second emission-related data using additional instructions associated with an additional selection made by the user.

16. The computer-implemented method of claim 1, further comprising:
presenting, based on the first selection, the second selection and the third selection, a fourth landscape comprising a fourth plurality of selection options to further determine how to generate the PCF value for the corporate entity;
obtaining a fourth selection of a fourth selection option among the fourth plurality of selection options from a second user of the customer, wherein the fourth selection comprises revised second instructions for processing the first emission-related data to generate revised second emission-related data; and
verifying that the fourth selection falls within the second set of current guidelines that apply to the first emission-related data.

17. The computer-implemented method of claim 1, further comprising:
presenting, based on the first selection, the second selection and the third selection, a fourth landscape comprising a fourth plurality of selection options to further determine how to generate the PCF value for the corporate entity;
obtaining a fourth selection of a fourth selection option among the fourth plurality of selection options from the user of the customer, wherein the fourth selection comprises third instructions for processing the initial emission-related data to generate third emission-related data, and wherein the third emission-related data is used to generate the PCF value;
verifying that the fourth selection falls within the first set of current guidelines that apply to the initial emission-related data;
presenting, based on the first selection, the second selection the third selection, and the fourth selection, a fifth landscape comprising a fifth plurality of selection options to further determine how to generate the PCF value for the corporate entity;
obtaining a fifth selection of a fifth selection option among the fifth plurality of selection options from the user of the customer, wherein the fifth selection directs the first emission-related data generated by the first selection to be an input for the fourth selection;
verifying that the fifth selection falls within a fourth set of current guidelines that apply to tying the first selection to the fourth selection;
obtaining a sixth selection from the user of the customer, wherein the sixth selection directs the third emission-related data generated by the fourth selection to be an input for the second selection; and
verifying that the sixth selection falls within a fourth set of current guidelines that apply to tying the fourth selection to the second selection.

18. The computer-implemented method of claim 1, wherein the first selection further comprises a model used in processing the initial emission-related data to generate the first emission-related data.

19. The computer-implemented method of claim 1, wherein the user is identified among a hierarchy of users of the customer, wherein the hierarchy dictates a level of authority that the user has in implementing the first instructions and the second instructions.

20. A product carbon footprint (PCF) determination apparatus comprising:
a PCF framework module; and
a controller communicably coupled to the PCF framework, wherein the controller is configured to:
present, using a landscape module of the PCF framework module, a first landscape comprising a first plurality of selection options to determine how to generate a PCF value for the corporate entity;
obtain a first selection of a first selection option among the first plurality of selection options from a customer, wherein the first selection comprises first instructions for processing initial emission-related data to generate first emission-related data, and wherein the initial emission-related data is associated with a business segment of the customer;
verify, using a selection processing module of the PCF framework module, in real time, that the first selection falls within a first set of current guidelines;
designate, using a data source designation module of the PCF framework module, in real time, a source of the initial emission-related data;
present, based on the first selection and using the landscape module of the PCF framework module, a second landscape comprising a second plurality of selection options to further determine how to generate the PCF value for the corporate entity;
obtain a second selection of a second selection option among the second plurality of selection options from the customer, wherein the second selection comprises second instructions for processing the first emission-related data to generate second emission-related data, and wherein the second emission-related data is used to establish the PCF value;
verify, in real time using the selection processing module of the PCF framework module, that the second selection falls within a second set of current guidelines;
present, using the landscape module of the PCF framework module, based on the first selection and the second selection, a third landscape comprising a third plurality of selection options to further determine how to generate the PCF value for the corporate entity;
obtain a third selection of a third selection option among the third plurality of selection options from the customer, wherein the third selection instructs the first emission-related data generated by the first selection to be an input for the second selection; and
verify, in real time using the selection processing module of the PCF framework module, that the third selection falls within a third set of current guidelines that apply to tying the first selection to the second selection.
